(19) United States
(12) Patent Application Publication
(10) Pub. No.: US 2013/0089662 A1
(43) Pub. Date: Apr. 11, 2013

(54) METHOD OF PRODUCING MASTER PLATE, METHOD OF PRODUCING ALIGNMENT FILM, METHOD OF PRODUCING RETARDATION FILM, AND METHOD OF PRODUCING DISPLAY DEVICE

(71) Applicant: Mitsunari Hoshi, Tokyo (JP)

(72) Inventor: Mitsunari Hoshi, Tokyo (JP)

(73) Assignee: DEXERIALS CORPORATION, Tokyo (JP)

(21) Appl. No.: 13/701,776

(22) PCT Filed: Jul. 5, 2011
(86) PCT No.: PCT/JP2011/065318

§ 371 Date: Dec. 3, 2012

(30) Foreign Application Priority Data
Jul. 12, 2010 (JP) 2010-157806

(51) Int. Cl. G02F 1/1337

(52) U.S. Cl. CPC G02F 1/13378
USPC 427/162; 264/400; 264/2.5

(57) ABSTRACT

Provided are a method of producing an alignment film from which a non-alignment thin film layer can be omitted, a method of producing a master plate that can be used for the production of the alignment film, a method of producing a retardation film using the alignment film, and a method of producing a display device provided with the retardation film using the alignment film.

### TECHNICAL FIELD

The present invention relates to a method of producing a master plate by using a femtosecond laser. The invention also relates to methods of producing an alignment film and a retardation film by using the master plate. The invention also relates to a method of producing a display devise provided with the retardation film.

### Background Art

In recent years, the development of displays capable of three-dimensional display is advancing. For example, in one three-dimensional display system, an image for the right eye of a viewer and an image for the left eye are displayed on the screen of a display, and the viewer observes these images through polarized glasses (see, for example Patent Literature 1). This system is implemented by disposing a patterned retardation film in front of a display capable of two-dimensional display, such as a cathode-ray tube, a liquid crystal display, or a plasma display. In such a retardation film, a pattern for retardation and optical axes must be designed at the pixel level of the display to control the polarization states of light entering the left and right eyes.

For example, Patent Literatures 1 and 2 disclose techniques for producing the above-described retardation film by partially patterning a liquid crystal material or a retardation material using, for example, a photoresist. However, these techniques have a problem in that, since the number of process steps is large, it is difficult to produce the retardation film at low cost. Patent Literature 3 discloses a technique for producing a retardation film by performing patterning using a photo-alignment film. More specifically, the photo-alignment film is formed on a substrate and then patterned using polarized ultraviolet light. Then the patterned photo-alignment film is coated with a polymerizable liquid crystal material (hereinafter referred to as a liquid crystalline monomer), and the liquid crystal molecules are aligned in a desired direction. Then the liquid crystalline monomer is polymerized by irradiation with ultraviolet light, and the retardation film is thereby produced. In a technique often used for liquid crystal displays, a polyimide alignment film is subjected to rubbing treatment to perform patterning.

However, the technique in Patent Literature 3 in which a photo-alignment film is used and the technique in which a polyimide alignment film is subjected to rubbing treatment have a problem in that light absorption or coloration occurs in the alignment film, causing a reduction in transmittance and therefore a reduction in use efficiency. In the technique using the photo-alignment film, the film must be partially irradiated with polarized ultraviolet light during patterning. Therefore, this technique has a problem in that the number of process steps is large.

As described in Patent Literature 4, the present applicant has proposed the production of a retardation film using a master plate having a strip pattern with a plurality of irregularities. The strip pattern is drawn by irradiating the surface of a substrate with a linearly polarized laser beam from a femtosecond laser and then scanning the surface with the laser beam, and the irregularities extend in a direction orthogonal to the polarization direction of the laser beam. This allows the retardation film to be produced by a simple process and can suppress the reduction in light utilization efficiency.

### CITATION LIST

### Patent Literature

Patent Literature 1: U.S. Pat. No. 5,676,975

Patent Literature 2: U.S. Pat. No. 5,327,285

Patent Literature 3: Japanese Patent No. 3881706

Patent Literature 4: WO/2010/032540

### SUMMARY OF THE INVENTION

However, the method described in Patent Literature 4 has a problem in that, since a pitch is about 700 nm, which is relatively large, the force for controlling the alignment of the liquid crystal is not so large. When the pitch is large, the depth of the irregularities must be increased in order to align the liquid crystal sufficiently. However, in this case, the following problem occurs. When a die having deep irregularities is used to form irregularities on the surface of a substrate and is then separated from an alignment film, a liquid crystal applied to the alignment film may not be easily aligned in a desired direction because of the influence of stress caused by the separation. This problem can be solved, for example, by forming a non-alignment thin film layer on the alignment film. However, this poses a new problem in that the production cost increases because the process for providing the non-alignment thin film layer is added.

The present invention has been made in view of the foregoing problems, and a first object of the invention is to provide a method of producing an alignment film from which a non-alignment thin film layer can be omitted. A second object is to provide a method of producing a master plate that can be used for the production of such an alignment film. A third object is to provide a method of producing a retardation film that uses such an alignment film. A fourth object is to provide a method of producing a display device including the retardation film that uses such an alignment film.

A method of producing a master plate according to the present invention includes: using a femtosecond laser to irradiate a surface of a base substrate with a linearly polarized laser beam with a fluence equal to or lower than a prescribed threshold value; and, at the same time, scanning the surface with the linearly polarized laser beam to draw a pattern including irregularities with a pitch equal to or smaller than one-half of a wavelength of the laser beam.

The above fluence is an energy density (J/cm²) per pulse and can be determined from the following formulas.

F=P/(f_{REPT}×S)

S=Lx×Ly

F: fluence

P: power of laser

f_{REPT}: repetition frequency of laser

S: area at position irradiated with laser beam

Lx×Ly: beam size

In the method of producing the master plate according to the present invention, the femtosecond laser beam with a fluence equal to or lower than the prescribed threshold value (i.e., a low fluence) is applied to draw the pattern including irregularities with a pitch equal to or smaller than one-half of the wavelength of the laser beam. For example, when a femtosecond laser beam with a wavelength of 800 nm and a repetition frequency of 1,000 Hz is applied to a SUS substrate at a fluence of 0.0 4 J/cm² or higher and 0.12 J/cm² or lower, irregularities with a pitch of about 80 nm are formed. For example, when a femtosecond laser beam with a wavelength of 800 nm and a repetition frequency of 1,000 Hz is applied to a NiP substrate at a fluence of 0.04 J/cm² or higher and 0.12 J/cm² or lower, irregularities with a pitch of about 240 nm are formed. Therefore, when, for example, a liquid crystal alignment film is produced using the master plate, the pitch of the irregularities on the alignment film can be equal to or smaller than one-half of the wavelength of the laser beam (400 nm or smaller in the above examples). Therefore, the alignment film has an increased anchoring force. For example, the alignment film is transferred from the master plate, and the master plate is separated. Then a polymerizable liquid crystal material is applied to the alignment film, then aligned, and polymerized. In this case, the influence of separation stress during transfer can be neglected.

A method of producing an alignment film according to the present invention includes the following two steps:

(A1) the step of forming a die, the step including using a femtosecond laser to irradiate a surface of a base substrate with a linearly polarized laser beam with a fluence equal to or lower than a prescribed threshold value and, at the same time, scanning the surface with the linearly polarized laser beam to draw a pattern including irregularities with a pitch equal to or smaller than one-half of a wavelength of the laser beam; and

(A2) the step of forming a plurality of grooves extending in a specific direction on a surface of a substrate using the die.

In the method of producing the alignment film according to the present invention, the alignment film is produced using the die having a pattern including irregularities with a pitch equal to or smaller than one-half of the wavelength of the laser beam, the irregularities being formed by irradiation with the femtosecond laser beam with a fluence equal to or lower than the prescribed threshold value (i.e., a low fluence). For example, the alignment film is produced by thermal transfer or transfer using a 2P (Photo Polymerization) molding method. The pitch of the irregularities on the alignment film is thereby equal to or smaller than one-half of the wavelength of the laser beam, and the alignment film has an increased anchoring force. For example, the alignment film is transferred from the master plate, and the master plate is separated. Then a polymerizable liquid crystal material is applied to the alignment film, then aligned, and polymerized. In this case, the influence of separation stress during transfer can be neglected.

A method of producing a retardation film according to the present invention includes the following four steps:

(B1) the step of forming a die, the step including using a femtosecond laser to irradiate a surface of a base substrate with a linearly polarized laser beam with a fluence equal to or lower than a prescribed threshold value and, at the same time, scanning the surface with the linearly polarized laser beam to draw a pattern including irregularities with a pitch equal to or smaller than one-half of a wavelength of the laser beam;

(B2) the step of forming a plurality of grooves extending in a specific direction on a surface of a substrate using the die;

(B3) the step of applying a polymerizable liquid crystal material to the surface of the substrate having the plurality of grooves formed thereon and then aligning the liquid crystal material; and

(B4) the step of polymerizing the liquid crystal material.

In the method of producing the retardation film according to the present invention, the alignment film is produced using the die having a pattern including irregularities with a pitch equal to or smaller than one-half of the wavelength of the laser beam, the irregularities being formed by irradiation with the femtosecond laser beam with a fluence equal to or lower than the prescribed threshold value (i.e., a low fluence). For example, the alignment film is produced by thermal transfer or transfer using the 2P molding method. The pitch of the irregularities on the alignment film is thereby equal to or smaller than one-half of the wavelength of the laser beam, and the alignment film has an increased anchoring force. The alignment film is transferred from the master plate, and the master plate is separated. Then the polymerizable liquid crystal material is applied to the alignment film, then aligned, and polymerized. In this case, the influence of separation stress during transfer can be neglected.

A method of producing a display device according to the present invention is a method of producing a display device provided with a retardation film includes the following four steps:

(C1) the step of forming a die, the step including using a femtosecond laser to irradiate a surface of a base substrate with a linearly polarized laser beam with a fluence equal to or lower than a prescribed threshold value and, at the same time, scanning the surface with the linearly polarized laser beam to draw a pattern including irregularities with a pitch equal to or smaller than one-half of a wavelength of the laser beam;

(C2) the step of forming a plurality of grooves extending in a specific direction on a surface of a substrate using the die;

(C3) the step of applying a polymerizable liquid crystal material to the surface of the substrate having the plurality of grooves formed thereon and then aligning the liquid crystal material; and

(C4) the step of polymerizing the liquid crystal material to form the retardation film.

In the method of producing the display device according to the present invention, the alignment film is produced using the die having a pattern including irregularities with a pitch equal to or smaller than one-half of the wavelength of the laser beam, the irregularities being formed by irradiation with the femtosecond laser beam with a fluence equal to or lower than the prescribed threshold value (i.e., a low fluence). For example, the alignment film is produced by thermal transfer or transfer using the 2P molding method. The pitch of the irregularities on the alignment film is thereby equal to or smaller than one-half of the wavelength of the laser beam, and the alignment film has an increased anchoring force. The alignment film is transferred from the master plate, and the master plate is separated. Then the polymerizable liquid crystal material is applied to the alignment film, then aligned, and polymerized. In this case, the influence of separation stress during transfer can be neglected.

In the methods of producing the master plate, alignment film, retardation film, and display device according to the present invention, the pitch of the irregularities on the alignment film transferred by using the die (master plate) formed using the femtosecond laser with a fluence equal to or lower than the prescribed threshold value (i.e., a low fluence) can be equal to or smaller than one-half of the wavelength of the laser beam. Therefore, the influence of separation stress can be neglected. This allows a non-alignment thin film layer to be omitted from the retardation film. Accordingly, while optical properties are improved, an increase in production cost can be suppressed.

### BRIEF DESCRIPTION OF DRAWINGS

FIG. 1 is a set of diagrams illustrating the schematic structure of a retardation film according to one embodiment of the present invention.

FIG. 2 is a cross-sectional view of a modification of the retardation film in FIG. 1.

FIG. 3 is a schematic diagram illustrating the detailed structure of the retardation film shown in FIG. 1.

FIG. 4 is a set of schematic diagrams illustrating the detailed structure of the retardation film shown in FIG. 1.

FIG. 5 is a diagram illustrating a method of producing a substrate shown in FIG. 1.

FIG. 6 is a cross-sectional view of the substrate produced by the method in FIG. 5.

FIG. 7 is a diagram showing the schematic structure of an apparatus used to produce the substrate shown in FIG. 2.

FIG. 8 is a cross-sectional view of the substrate produced by the method in FIG. 7.

FIG. 9 is a set of diagrams illustrating a method of producing a retardation film that uses the substrate produced by the method in FIG. 5 or 7.

FIG. 10 is a diagram illustrating a method of producing a die.

FIG. 11 is a diagram showing the distribution of the intensity of a beam spot from an ultra short pulse laser used to produce the die.

FIG. 12 is a diagram showing an example of a scanning procedure for the beam spot in FIG. 11.

FIG. 13 is a diagram showing another example of the scanning procedure for the beam spot in FIG. 11.

FIG. 14 is a diagram showing an example of an apparatus used to produce the die.

FIG. 15 is a diagram showing another example of the apparatus used to produce the die.

FIG. 16 is a diagram showing an example of the scanning procedure for the beam spot in the apparatus in FIG. 14 or 15.

FIG. 17 is a diagram showing another example of the scanning procedure for the beam spot in the apparatus in FIG. 14 or 15.

FIG. 18 is a graph showing the relation between laser conditions for a SUS substrate and irregularities formed.

FIG. 19 is a graph showing the relation between laser conditions for a NiP substrate and irregularities formed.

FIG. 20 is a table showing the laser processing conditions for some of a plurality of solid diamonds in FIG. 18 and the laser processing conditions for some of a plurality of solid triangles in FIG. 19, together with the pitch of irregularities formed, an arithmetic mean roughness Ra, and the presence or absence of liquid crystal alignment.

FIG. 21 is a set of graphs obtained by measuring the irregularities in S3 and N3 in FIG. 20 using an AFM.

FIG. 22 is a graph showing laser conditions under which the pitch of irregularities formed on a DLC substrate becomes equal to or smaller than one-half of the laser wave length.

FIG. 23 is a graph showing laser conditions under which the pitch of irregularities formed on an FDLC substrate becomes equal to or smaller than one-half of the laser wavelength.

FIG. 24 is a graph showing a cross-sectional shape of irregularities on a die under conditions D1.

FIG. 25 is a graph showing a cross-sectional shape of irregularities in a die under conditions F1.

FIG. 26 is a top plan view of a substrate in a retardation film in modification 1.

FIG. 27 is a set of cross-sectional views showing the schematic structure of a retardation film according to modification 2.

FIG. 28 is a cross-sectional view showing the schematic structure of a display device according to application example 1.

FIG. 29 is a schematic diagram showing the stacking structure of the display device shown in FIG. 28.

FIG. 30 is a schematic diagram showing a retardation film and a polarizer according to another example in application example 1.

FIG. 31 is a cross-sectional view showing the schematic structure of a display device according to application example 2.

FIG. 32 is a schematic diagram showing the stacking structure of the display device shown in FIG. 31.

FIG. 33 is a cross-sectional view showing the schematic structure of a display device according to application example 3.

### DESCRIPTION OT EMBODIMENTS

Modes for carrying out the invention (hereinafter referred to as embodiments) will next be described in detail with reference to the drawings. The description will be made in the following order.

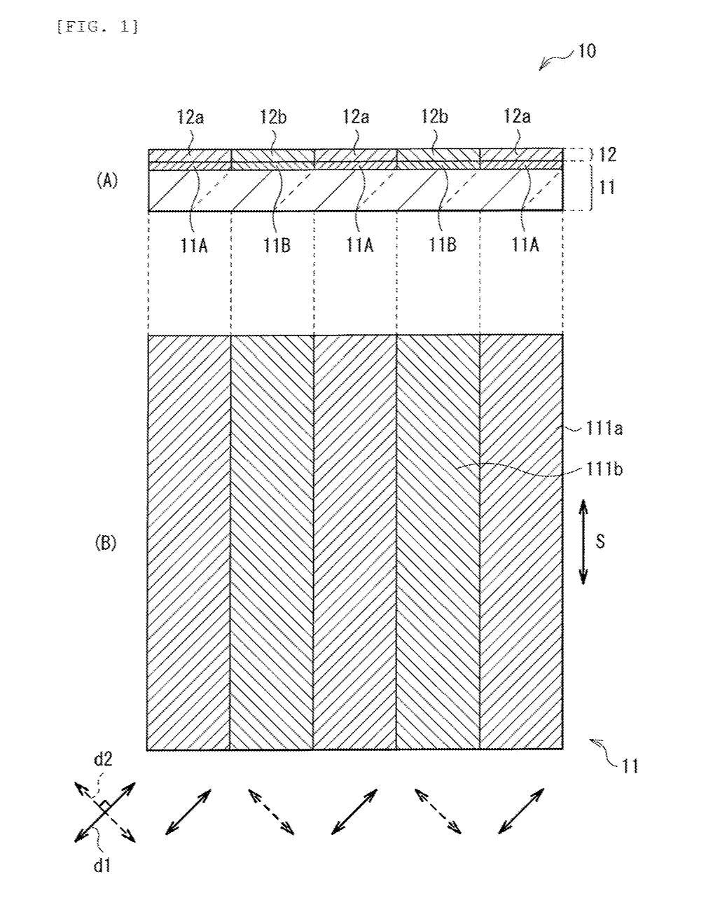

1. Embodiments (FIGS. 1 to 25)

1.1 Configuration of retardation film

1.2 Method of producing retardation film

1.3 Method of producing die

1.4 Effects

2. Modifications (FIGS. 26 to 29)

3. Application examples (FIGS. 30 to 33)

### 1. Embodiments

### [1.1 Configuration of Retardation Film]

FIG. 1(A) is a diagram showing an example of the cross-sectional structure of a retardation film 10 produced by a production method according to one embodiment of the present invention. FIG. 1(B) shows a substrate 11 in FIG. 1(A), as viewed from its front surface side. The retardation film 10 includes, for example, a retardation layer 12 formed on the substrate 11, as shown in FIG. 1(A). The substrate 11 includes groove regions 11A and 11B disposed on its surface toward the retardation layer 12, and the retardation layer 12 is in contact with the groove regions 11A and 11B.

The substrate 11 is formed of a thermoplastic material such as plastic, specifically polymethyl methacrylate, polycarbonate, polystyrene, or the like. When the retardation film 10 is used for a polarized-glasses type display device 1 described later, the retardation of the substrate 11 is preferably as small as possible. Therefore, it is preferable that the substrate 11 be formed of an amorphous cycloolefin polymer, an alicyclic acrylic resin, or a norbornene-based resin. The thickness of the substrate 11 is, for example, 30 μm to 500 μm.

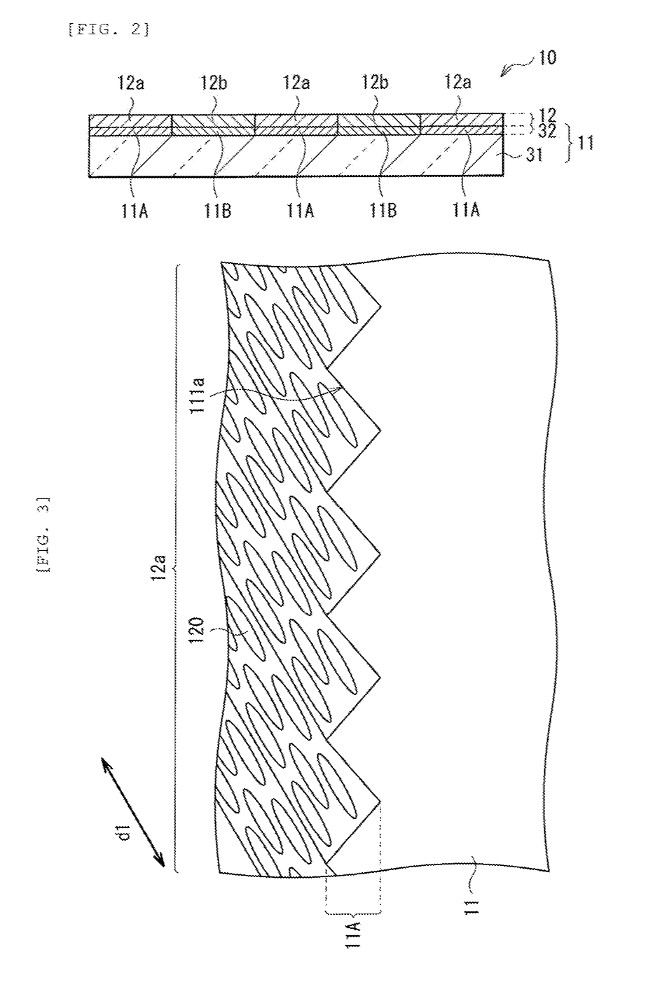

The substrate 11 may have, for example, a single-layer structure or a multilayer structure. When the substrate 11 has a multilayer structure, the substrate 11 has, for example, a two-layer structure including a substrate 31 and a resin layer 32 formed on the surface of the substrate, as shown in FIG. 2. The resin layer 32 is different from a photo-alignment film and a polyimide alignment film, and almost no light absorption and coloration occur in the resin layer 32. In the example shown in FIG. 2, the groove regions 11A and 11B have been patterned on the resin layer 32 formed on the outermost surface of the substrate 11.

The groove regions 11A and 11B have, for example, a stripe shape and are arranged alternately on the surface of the substrate 11. The width of the stripes is equal to, for example, the pitch of pixels of a display device. Each of the groove regions 11A is configured to include a plurality of grooves 111a. The width of each groove 111a is, for example, several tens of nanometers to several hundreds of nanometers, and the depth of each groove 111a is, for example, several nanometers to several hundreds of nanometers. The plurality of grooves 111a extend in one direction d1. Each of the groove regions 11B is configured to include a plurality of grooves 111b. The width of each groove 111b is, for example, several tens of nanometers to several hundreds of nanometers, and the depth of each groove 111b is, for example, several nanometers to one hundred nanometers. The plurality of grooves 111b extend in one direction d2. For example, the directions d1 and d2 are orthogonal to each other. For example, the directions d1 and d2 form angles of −45° and +45°, respectively, with respect to a stripe direction S of the groove regions 11A and 11B.

The retardation layer 12 includes retardation regions 12a and 12b. The retardation regions 12a and 12b have, for example, a stripe shape and are arranged alternately. The width of the stripes is equal to, for example, the pitch of the pixels of the display device. The retardation regions 12a are disposed facing (in contact with) the groove regions 11A, and the retardation regions 12b are disposed facing (in contact with) the groove regions 11B. The retardation regions 12a and 12b have different retardation characteristics. More specifically, each retardation region 12a has a slow axis AX1 in the extending direction d1 of the grooves 111a, and each retardation region 12b has a slow axis AX2 in the extending direction d2 of the grooves 111b. For example, the retardation axes AX1 and AX2 are orthogonal to each other.

The retardation value of the retardation layer 12 is set by controlling the thicknesses and materials of the retardation regions 12a and 12b. When the substrate 11 has a retardation, it is preferable that the retardation value of the retardation layer 12 be set also in consideration of the retardation of the substrate 11. In this embodiment, the retardation regions 12a and 12b are formed of the same material and have the same thickness, and their absolute retardation values are thereby equal to each other. For example, the retardation of the retardation regions 12a is −λ/4, and the retardation of the retardation regions 12b is +λ/4. The signs of the retardations are opposite to each other, and this means that the difference between, the directions of the retardation axes is 90°. In actual materials, it is difficult that a retardation of λ/4 is satisfied for all wavelengths. Therefore, preferably, the retardation regions 12a and 12b are designed such that a retardation of λ/4 is satisfied in a wavelength range of green color that is more sensible to human eyes, i.e., at any wavelength from 500 to 560 nm.

The retardation layer 12 is formed to include, for example, a polymerized polymer liquid crystal material. More specifically, in the retardation layer 12, the alignment state of liquid crystal molecules has been fixed. The polymer liquid crystal material to be used is selected according to its phase transition temperature (liquid crystal phase-isotropic phase), the refractive index wavelength dispersion characteristics and viscosity characteristics of the liquid crystal material, a process temperature, etc. Preferably, the polymer liquid crystal material has an acryloyl group or a methacryloyl group as a polymerizable group, from the viewpoint of transparency. Preferably, the polymer liquid crystal material used includes no methylene spacer between the polymerizable functional group and the liquid crystal skeleton. This is because a lower alignment treatment temperature can be used during the process. The thickness of the retardation layer 12 is, for example, 1 μm to 2 μm. When the retardation layer 12 is formed to include a polymerized polymer liquid crystal material, the retardation layer 12 is not necessarily formed only of the polymerized polymer liquid crystal material and may partially include an unpolymerized liquid crystalline monomer. This is because the unpolymerized liquid crystalline monomer contained in the retardation layer 12 has been aligned in the same direction as the alignment direction of liquid crystal molecules around the unpolymerized liquid crystalline monomer by alignment treatment (heat treatment) described later and has the same alignment characteristics as those of the polymer liquid crystal material.

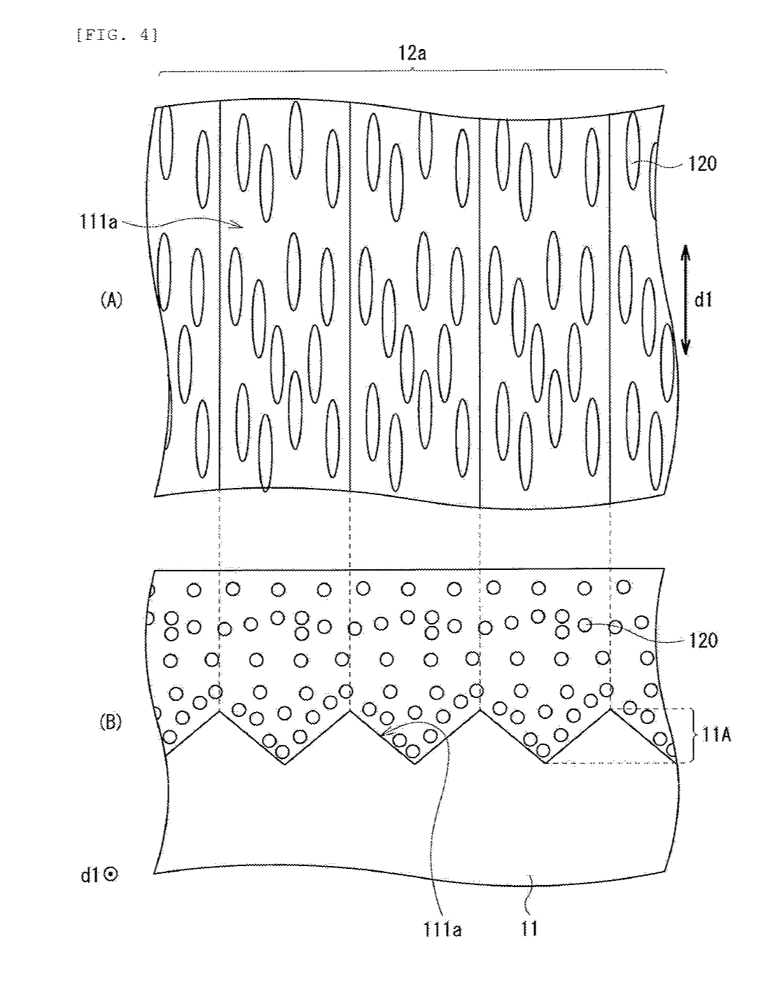

Referring now to FIGS. 3, 4(A), and 4(B), the detailed structures of the groove regions 11A and 11B and the retardation layer 12 will be described. FIG. 3 is a schematic perspective view illustrating an example of the state of a groove region 11A and a retardation region 12a at their interface. FIG. 4(A) is a top plan view around the interface in FIG. 3, and FIG. 4(B) is a cross-sectional view around the interface. Around the interface between the groove region 111a and the retardation region 12a, liquid crystal molecules 120 are arranged such that their major axes extend, for example, in the extending direction d1 of the grooves 111a. In. addition, for example, liquid crystal molecules 120 in the upper portion of the retardation region 12a are also arranged extending in the direction d1 so as to follow the alignment direction of liquid crystal molecules in the lower portion. More specifically, in the retardation regions 12a, for example, the alignment of liquid crystal molecules 120 is controlled by the shape of the grooves 111a extending in the direction d1, and the optical axes of the retardation regions 12a are thereby set. Similarly, although not shown, around the interfaces between the groove regions 111b and the retardation regions 12b, liquid crystal molecules 120 are arranged such that their major axes extend, for example, in the extending direction d2 of the grooves 111b. In addition, for example, liquid crystal molecules 120 in the upper portions of the retardation regions 12b are also arranged extending in the direction d2 so as to follow the alignment direction of liquid crystal molecules 120 in the lower portion. More specifically, in the retardation regions 12b, for example, the alignment of liquid crystal molecules 120 is controlled by the shape of the grooves 111b extending in the direction d2, and the optical axes of the retardation regions 12b are thereby set. When a nematic liquid crystal is used as the material of the liquid crystal molecules 120, the direction of the major axes of the liquid crystal molecules 120 is a slow axis direction, and therefore the extending direction of the grooves is the slow axis direction.

### [1.2 Method of Producing Retardation Film]

An example of a method of producing the retardation film 10 will next be described. In the following description, the production of the substrate 11 by a thermal transfer method will first be described, and then the production of the substrate 11 by a so-called 2P molding method (Photo Polymerization: a molding method using photo curing) will be described. Then a method of producing the retardation film 10 using the substrate 11 produced by any of the above methods will be described.

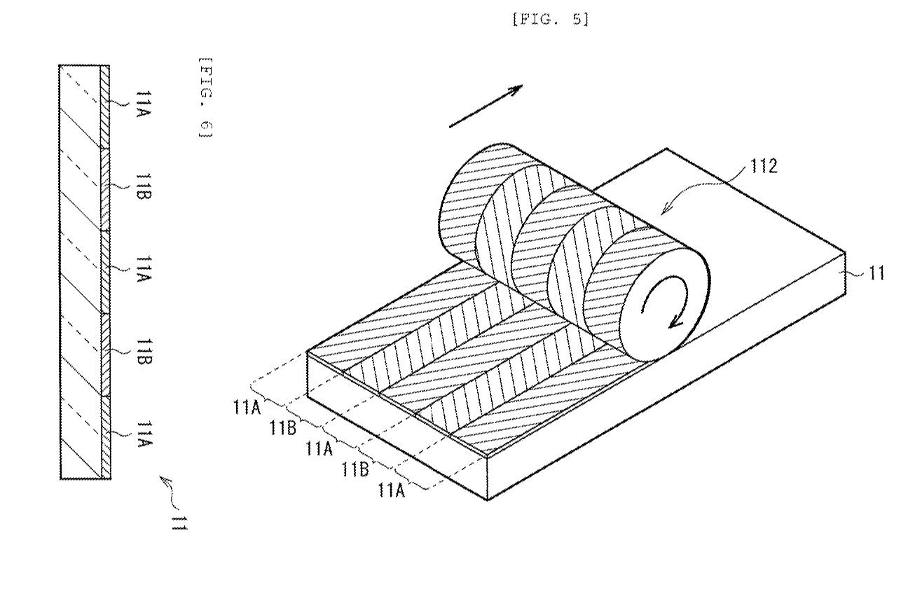

FIG. 5 shows a process of producing the substrate 11 by the thermal transfer method. As shown in FIG. 5, groove regions 11A and 11B are patterned on the surface of the substrate 11. The substrate 11 used may have a single layer structure or a multilayer structure (for example, a two-layer structure including a resin layer formed on the surface of the substrate). In this case, for example, a die roll 112 having a reversal pattern of the pattern in which stripe-shaped groove regions 11A and 11B are arranged alternately is used for transfer to simultaneously form the pattern in which the stripe-shaped groove regions 11A and 11B are arranged alternately. More specifically, the substrate 11 formed of the above-described material is heated to near its glass-transition temperature, and the die roll 112 is pressed against the surface of the heated substrate 11, then cooled, and separated from the substrate 11. The groove regions 11A and 11B are thereby formed over the entire surface of the substrate 11. In this manner, the substrate 11 having the groove regions 11A and 11B on its surface (a grooved substrate, an alignment film) is formed (FIG. 6).

The above-described die roll 112 having a roll shape can be used as a transfer die, but a die having a flat plate-like shape may be used. However, the use of the roll-shaped die can further improve mass productivity. In either case, a die produced using a method of producing a die (master plate) described later is used to form the substrate 11.

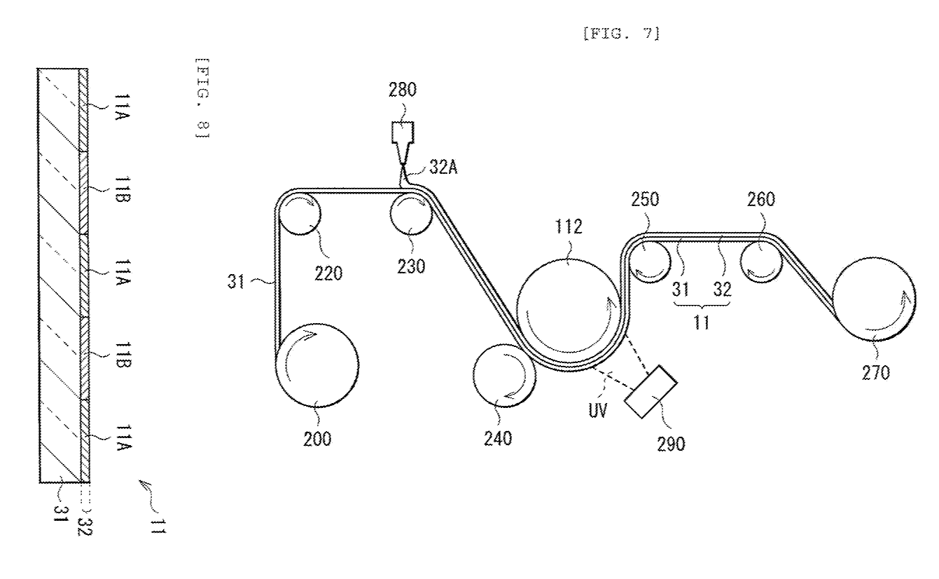

FIG. 7 shows an example of an apparatus for producing the substrate 11 using the 2P molding method. In the 2P molding method, for example, an ultraviolet or electron beam curable resin material is applied to a substrate to form a resin layer, and a die having a reversal pattern for the groove regions is pressed against the formed resin layer. Then an energy beam such as an ultraviolet beam or an electron beam is applied to the resin layer to cure it, and the pattern on the die is thereby transferred to the surface of the resin layer. The configuration of the production apparatus shown in FIG. 7 and a method of producing the substrate 11 using the production apparatus will next be described.

The production apparatus shown in FIG. 7 includes a feeding roll 200, guide rolls 220, 230, 250, and 260, a nip roll 240, a die roll 112, a take-up roll 270, a discharging unit 280, and a UV irradiation unit 290. The feeding roll 200 includes a film-shaped substrate 31 wound concentrically and is used to supply the substrate 31. The substrate 31 unwound from the feeding roll 200 passes through the guide roll 220, the guide roll 230, the nip roll 240, the die roll 112, the guide roll 250, and the guide roll 260 in that order and is finally wound by the take-up roll 270. The guide rolls 220 and 230 are used to guide the substrate 31 supplied from the feeding roll 200 to the nip roll 240. The nip roll 240 is used to press the substrate 31 supplied from the guide roll 230 against the die roll 112. The die roll 112 is disposed with a prescribed gap between the die roll 112 and the nip roll 240. A reversal pattern for the groove regions 11A and 11B (groove regions 111A and 111B) has been formed on the circumferential surface of the die roll 112. The guide roll 250 is used to separate the substrate 31 wound around the die roll 112 therefrom. The guide roll 260 is used to guide the substrate 31 separated by the guide roll 250 to the take-up roll 270. The discharging unit 280 is disposed at a prescribed distance from a portion of the substrate 31 supplied from the feeding roll 200 with the portion being in contact with the guide roll 230. The discharging unit 280 is configured such that a composition prepared by optionally adding an additive such as a photo-polymerization initiator to an ultraviolet or electron beam curable liquid resin material is dropped onto the substrate 31 to form a resin layer 32A. The UV irradiation unit 290 is configured such that an ultraviolet beam is applied to a portion of the substrate 31 supplied from the feeding roll 200 with the portion having passed through the nip roll 240 and being in contact with the die roll 112. When the resin material dropped from the discharging unit 280 is of the electron beam curable type, an electron beam irradiation unit (not shown) is provided instead of the UV irradiation unit 290 that applies an ultraviolet beam.

The substrate 11 is formed using the production apparatus having such a configuration. More specifically, the substrate 31 unwound from the feeding roll 200 is first guided to the guide roll 230 through the guide roll 220, and the above-described composition is dropped onto the substrate 31 from the discharging unit 280 to form a resin layer 32A (uncured energy curable resin layer). Next, the nip roll 240 presses the resin layer 32A against the circumferential surface of the die roll 112 through the substrate 31. The resin layer 32A thereby comes into contact with the circumferential surface of the die roll 112 with no gap, and the irregularities formed on the circumferential surface of the die roll 112 are transferred onto the resin layer 32A.

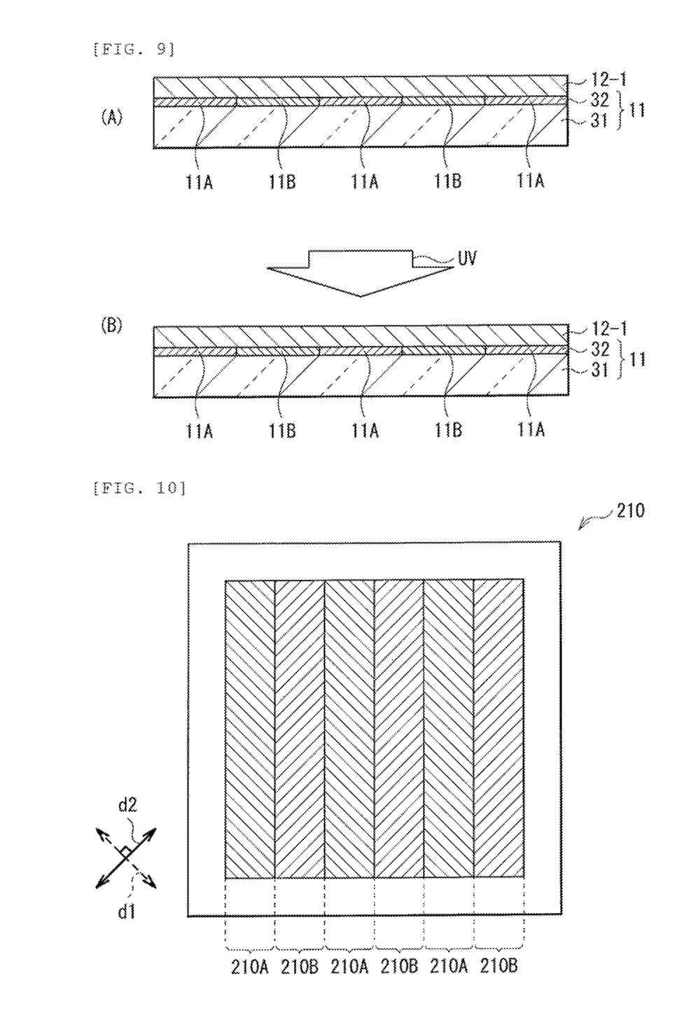

Then a UV beam is applied to the resin layer 32A having the irregularities transferred thereon from the UV irradiation unit 290. The liquid crystalline monomer contained in the resin layer 32A is thereby polymerized, so that the liquid crystalline monomer is converted to a polymer liquid crystal aligned in the extending direction of the irregularities formed on the circumferential surface of the die roll 112. Therefore, a resin layer 32 is formed on the substrate 31. Finally, the guide roll 250 separates the substrate 31 from the die roll 112, and the substrate 31 is wound around the take-up roll 270 through the guide roll 260. In this manner, a substrate 11 having the resin layer 32 on the surface of the substrate 31 is formed (FIG. 8).

When the substrate 31 is formed of a material that does not allow a UV beam to pass therethrough, the die roll 112 may be formed of a material that allows the UV beam to pass therethrough (for example, quartz), and the UV beam may be applied to the resin layer 32A from the inside of the die roll 112.

A description will next be given of a method of producing the retardation film 10 using the substrate 11 produced by any of the above-described methods.

FIGS. 9(A) and 9(B) show a process of producing the retardation film 10 using the substrate 11. As shown in FIG. 9(A), a liquid crystal layer 12-1 containing the liquid crystalline monomer is formed on the surface of the substrate 11 having groove regions 11A and 11B patterned thereon. In this case, a polymer compound with no methylene spacer between a polymerizable functional group and a liquid crystal skeleton is used for the liquid crystal layer 12-1. Since the liquid crystal layer 12-1 is in a nematic phase at around room temperature, the heating temperature for alignment treatment in the subsequent step can be lowered.

In this case, a solvent for dissolving the liquid crystalline monomer, a polymerization initiator, a polymerization inhibitor, a surfactant, a leveling agent, etc. are used for the liquid crystal layer 12-1 if necessary. Mo particular limitation is imposed on the solvent. However, it is preferable to use a solvent having a high ability to dissolve the liquid crystalline monomer, low vapor pressure at room temperature, and resistance to evaporation at room temperature.

Next, the liquid crystalline monomer in the liquid crystal layer 12-1 applied to the surface of the substrate 11 is subjected to alignment treatment (heat treatment). This heat treatment is performed at a temperature equal to or higher than the phase transition temperature of the liquid crystalline monomer or, when a solvent is used, at a temperature equal to or higher than the temperature at which the solvent is dried, for example, 50° C. to 130° C. However, it is important to control the rate of temperature increase, retention temperature, time, the rate of temperature decrease, etc. For example, a liquid crystal layer 12-1 prepared by dissolving a liquid crystalline monomer having a phase transition temperature of 52° C. in 2-methoxy-1-acetoxypropane (PGMEA) such that the solid contents are 30% by weight may be used. In this case, the liquid crystal layer 12-1 is first heated at a temperature, for example, about 70° C., that is equal to or higher than the phase transition temperature (52° C.) of the liquid crystalline monomer and allows the solvent to be dried and is then held at this temperature for several minutes.

In this case, shear stress caused by the liquid crystalline monomer coating formed in the previous step acts on the interface between the liquid crystalline monomer and the substrate. This may cause the liquid crystal molecules to be aligned by flow (flow-induced alignment) or by force (external force induced alignment), and the liquid crystal molecules may be aligned in an unintended direction. The above-described heat treatment is performed to temporarily cancel the alignment state of the liquid crystalline monomer aligned in such an unintended direction. The solvent in the liquid crystal layer 12-1 is thereby dried. Only the liquid crystalline monomer remains, and the state of the liquid crystalline monomer is in an isotropic phase.

Then the liquid crystal layer 12-1 is slowly cooled to a temperature slightly lower than the phase transition temperature (52° C.), for example, 47° C., at a rate of about 1 to about 5° C./min. By cooling the liquid crystal layer 12-1 to a temperature equal to or lower than the phase transition temperature, the liquid crystalline monomer is aligned according to the pattern for the groove regions 11A and 11B formed on the surface of the substrate 11. More specifically, the liquid crystalline monomer is aligned in the extending directions d1 and d2 of the grooves 111a and 111b.

Next, as shown in FIG. 9(B), the liquid crystal layer 12-1 having been subjected to the alignment treatment is irradiated with UV light to polymerize the liquid crystalline monomer. The treatment temperature is generally around room temperature. However, to control the retardation value, the temperature may be increased to a temperature equal to or lower than the phase transition temperature. The use of UV light is not a limitation, and heat, an electron beam, etc., may be used. However, the use of UV light can simplify the process. The alignment states of the liquid crystal molecules are thereby fixed in the directions d1 and d2, and a liquid crystal layer 12 including the retardation regions 12a and 12b is formed. In this manner, a retardation film 10 having the liquid crystal layer 12 on the substrate 11 is completed.

### [1.3 Method of Producing Die]

A description, will next be given of an example of a method of producing a die (master plate) used to produce a substrate 11.

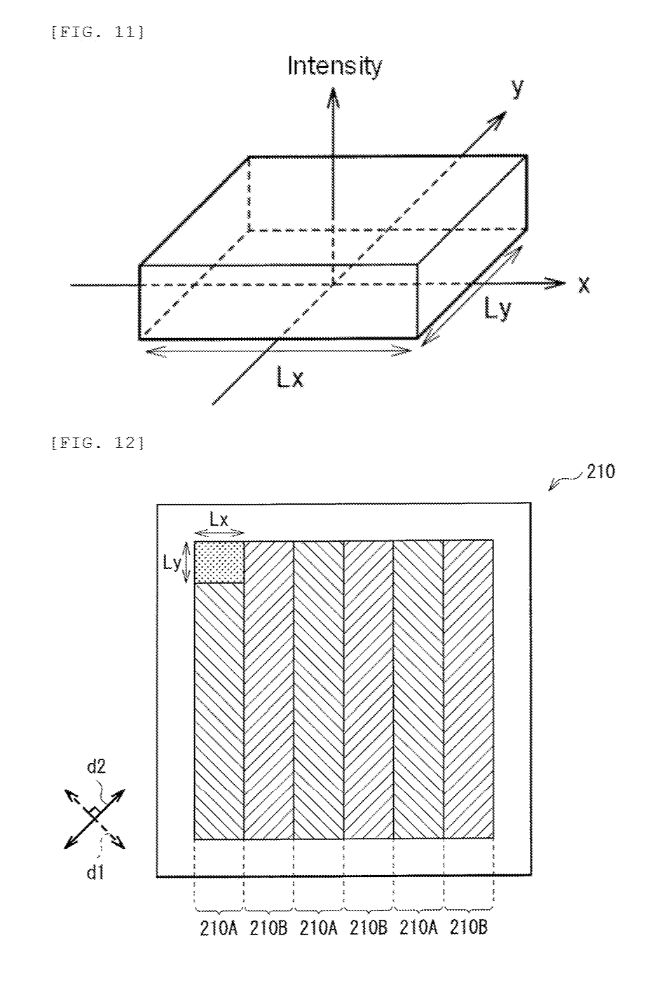

The die (master plate) used to produce the retardation film 10 is formed by, for example, drawing a pattern, for example, a pattern including pattern regions 210A and 210B on a die 210 shown in FIG. 10, on, for example, a metal such as SUS, NiP, Cu, Al, or Fe using an ultra short pulse laser, or a so-called femtosecond laser, with a pulse width of 1 picosecond (10⁻¹² seconds) or shorter. The polarization state of the laser beam is linear polarization. When the pattern regions 210A are formed, the angle of the polarization direction of the laser beam is set to the extending direction d1 of irregularities, and the laser beam is applied to an area in which a pattern region 210A is to be formed and is moved along this area. When the pattern regions 210B are formed, the angle of the polarization direction of the laser beam is set to the extending direction d2 of irregularities, and the laser beam is applied to an area in which a pattern region 210B is to be formed and is moved along this area. In this case, when the extending direction of irregularities intersects the extending direction S of the pattern regions 210A and 210B, the angle of the polarization direction of the laser beam is set to a direction intersecting the direction of scanning with the laser beam. When the extending direction of irregularities is the same as the extending direction S of the pattern regions 210A and 210B, the angle of the polarization direction of the laser beam is set to the direction of scanning with the laser beam.

By appropriately setting the wavelength of the laser, the repetition frequency, the pulse width, the beam spot shape, the polarization, the intensity of the laser beam applied to the sample, the scanning speed of the laser beam, etc., pattern regions 210A and 210B with the desired irregularities can be formed.

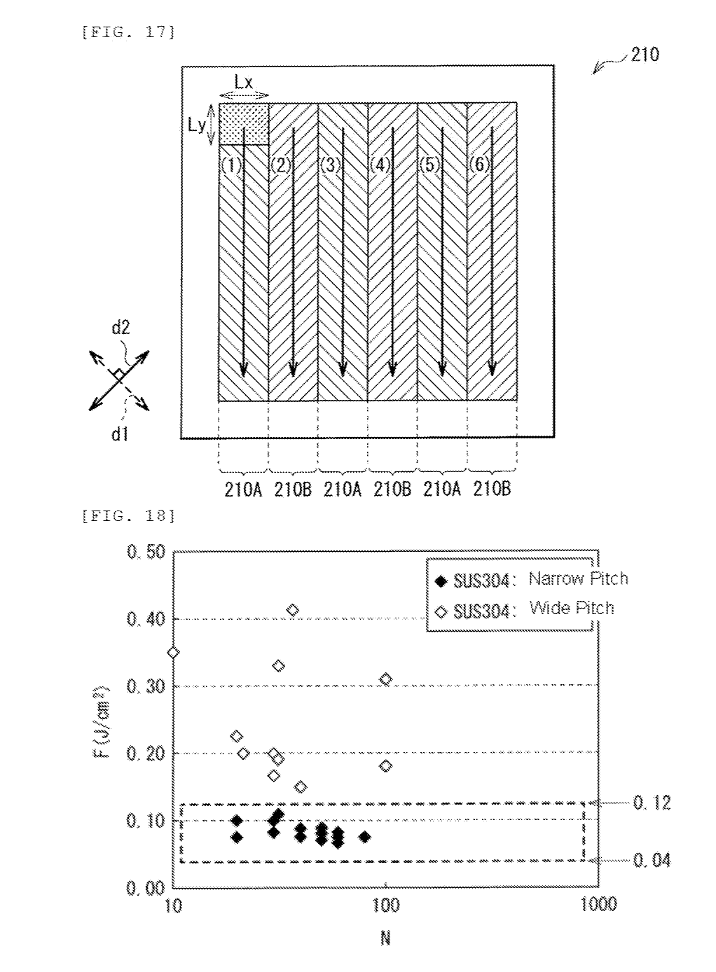

The wavelength of the laser used for laser processing is, for example, 800 nm. However, the wavelength of the laser used for the laser processing may be, for example, 400 nm or 266 nm. In consideration of processing time and a small pitch of irregularities to foe formed, the larger the repetition frequency, the more preferable. The repetition frequency is preferably 1,000 Hz or larger. The shorter the pulse width of the laser, the more preferable. The pulse width is preferably about 200 femtoseconds (10¹⁵ seconds) to about 1 picosecond (10⁻¹² seconds). Preferably, the beam spot of the laser beam applied to the die has a rectangular shape. The beam spot can foe shaped by using, for example, an aperture or a cylindrical lens (see FIGS. 14 and 15).

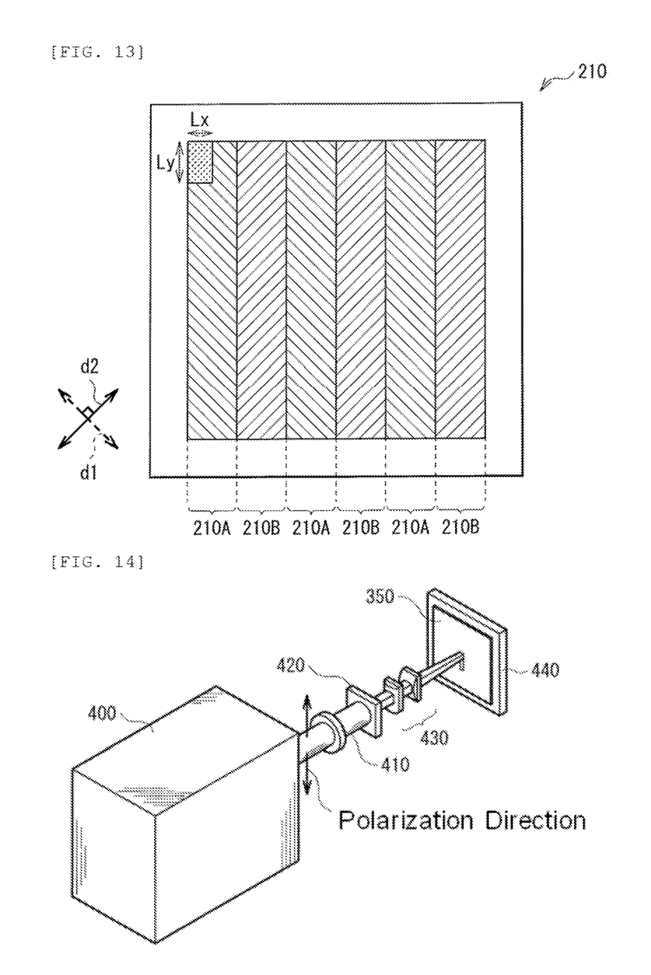

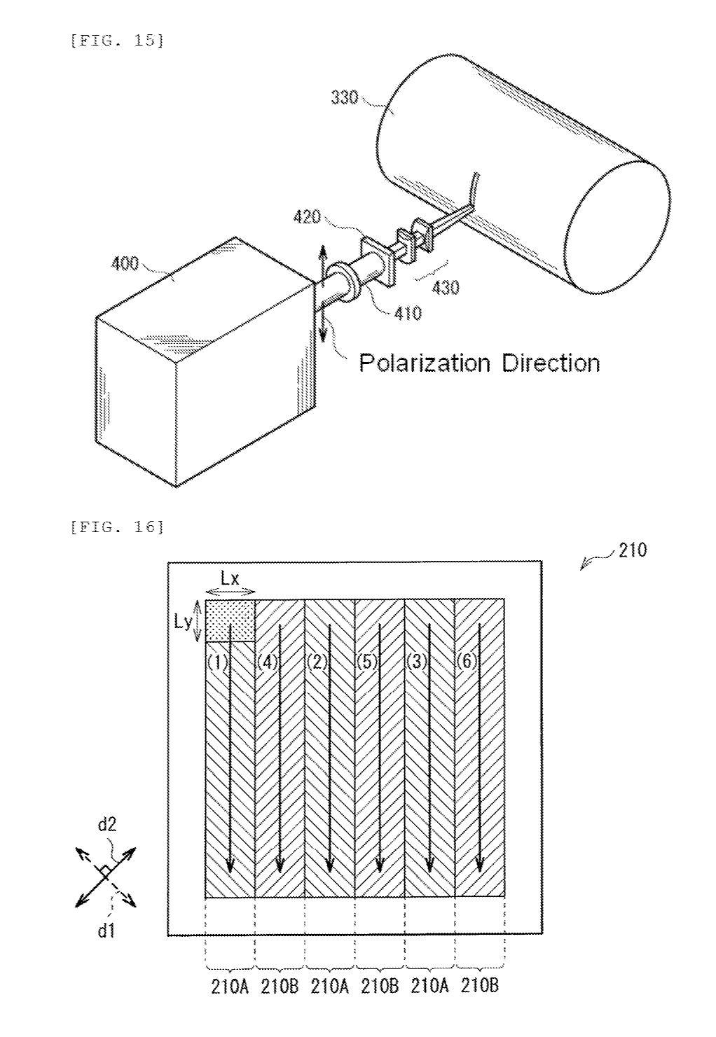

The distribution of intensity in the beam spot is preferably as uniform as possible as shown in, for example, FIG. 11. This is because it is desirable that the in-plane distribution of, for example, the depth of irregularities formed on the die be as uniform as possible. Let the size of the beam spot be Lx×Ly and the direction of scanning with the laser be a y-direction, as shown in FIG. 12. Then Lx is determined by the width of a pattern region to be processed. For example, the size Lx may be approximately equal to the size of the pattern regions 210A, as shown in FIG. 12. The size Lx may be approximately one-half of the size of the pattern regions 210A, as shown in FIG. 13. In this case, each pattern region 210A is formed by two scanning operations. In addition, the size Lx may be set to 1/N (N is a natural number) of the size of the pattern regions 210A. In this case, each pattern region 210A is formed by N scanning operations. Ly can be appropriately determined according to the speed of a stage, the laser intensity, the repetition frequency, etc. and is, for example, about 30 to about 1,000 μm.

The detail of the method of producing the die 210 will be described. FIGS. 14 and 15 show examples of an optical apparatus used for laser processing. FIG. 14 shows an example of the optical apparatus used to produce a flat die, and FIG. 15 shows an example of the optical apparatus used to produce a roll-shaped die.

A laser main body 400 is IFRIT (product name) manufactured by Cyber Laser Inc. The laser wavelength is 800 nm, the repetition frequency is 1,000 Hz, and the pulse width is 220 fs. The laser main body 400 emits a laser beam linearly polarized in a vertical direction. Therefore, in this apparatus, a wave plate 410 (a λ/2 wave plate) is used to rotate the polarization direction, and linear polarization in a desired direction is thereby obtained. In this apparatus, an aperture 420 having a rectangular opening is used to extract part of the laser beam. More specifically, since the intensity distribution of the laser beam is a Gaussian distribution, the use of only the light around the center allows a laser beam with a uniform in-plane intensity distribution to be obtained. In this apparatus, two orthogonal cylindrical lenses 430 are used to narrow the laser beam, and a desired beam size is thereby obtained.

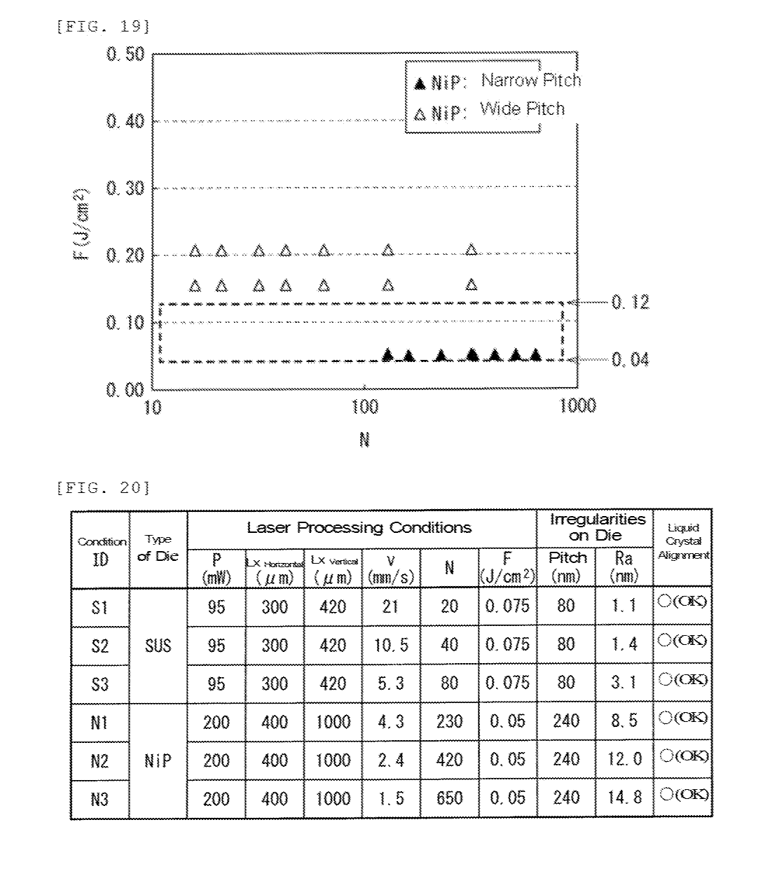

When a flat plate 350 is processed, a linear stage 440 is moved at a constant speed. For example, as shown in FIG. 16, first, only the pattern regions 210A may be sequentially scanned, and then the pattern regions 210B may be sequentially scanned. Numbers in parentheses in FIG. 16 indicate the order of scanning. With the above scanning method, when the pattern regions 210A are scanned, the angle of the wave plate 410 is set to a prescribed angle so that the angle of the polarization direction of the laser beam is set to the extending direction d1 of irregularities. When the pattern regions 210B are scanned, the angle of the wave plate 410 is set to another prescribed angle so that the angle of the polarization direction of the laser beam is set to the extending direction d2 of irregularities.

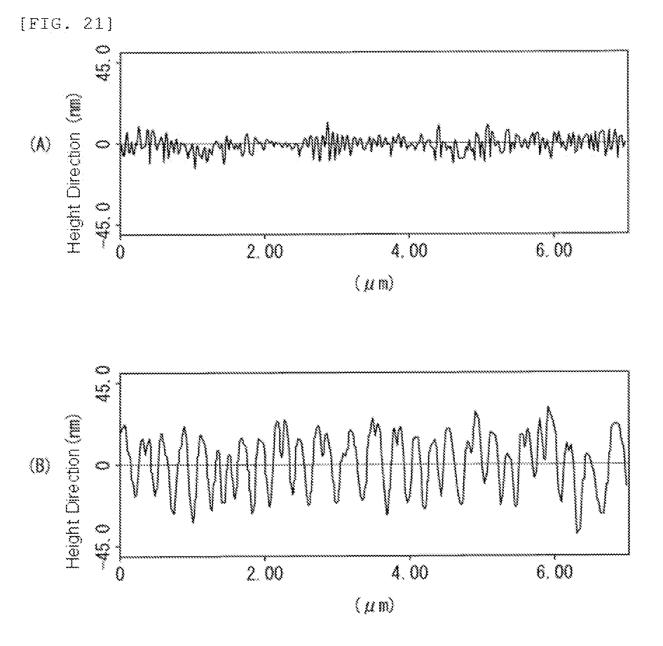

For example, as shown in FIG. 17, the pattern regions 210A and the pattern regions 210B may be scanned alternately. With this scanning method, in order to change the direction of polarization, the angle of the wave plate 410 must be changed when a pattern region 210B is processed after a pattern region 210A is processed and when a pattern region 210A is processed after a pattern region 210B is processed.

When a roll 330 is processed, the linear stage 440 is not moved, but the roll 330 is rotated instead. The procedure for scanning with the laser beam when the roll 330 is processed is the same as the procedure for scanning with the laser beam when the flat plate 350 is processed.

Next, conditions for the laser beam actually used to process a die will be described.

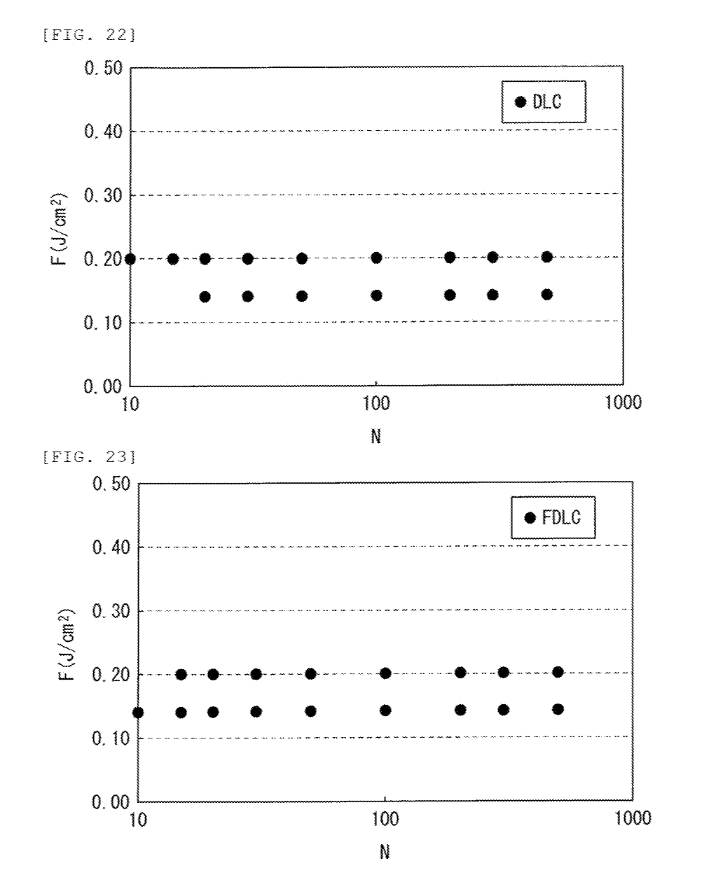

FIG. 18 shows the relation between laser conditions for a SUS substrate and irregularities formed. FIG. 19 shows the relation between laser conditions for a NiP substrate and irregularities formed. As can been seen from FIGS. 18 and 19, when a femtosecond laser beam with a fluence equal to or lower than a prescribed threshold value was applied to a substrate, irregularities with a small pitch equal to or smaller than one-half of the wavelength of the laser beam were formed. More specifically, as can be seen from FIG. 18, when a femtosecond laser beam with a wavelength of 800 nm and a repetition frequency of 1,000 Hz was applied to a SUS substrate at a fluence of 0.04 J/cm² or higher and 0.12 J/cm² or lower, irregularities with a small pitch of about 50 to about 200 nm were formed (solid diamond dots in FIG. 18). Similarly, as can be seen from FIG. 19, when a femtosecond laser beam with a wavelength of 800 nm and a repetition frequency of 1,000 Hz was applied to a NiP substrate at a fluence of 0.04 J/cm² or higher and 0.12 J/cm² or lower, irregularities with a small pitch of about 100 to about 300 nm were formed (solid triangle dots in FIG. 19). As can be seen, so long as the fluence of a single pulse is equal to or lower than the prescribed threshold value, the pitch of irregularities formed on a substrate can be equal to or smaller than the wavelength of the applied laser beam, irrespective of the material of the substrate.

The fluence described above is an energy density (J/cm²) per pulse and can be determined from the following formulas.

F=P/(f_{REPT}×S)

S=Lx×Ly

F: fluence

P: power of laser

f_{REPT}: repetition frequency of laser

S: area at position irradiated with laser beam

Lx×Ly: beam size

When a laser beam with a wavelength of 800 nm and a repetition frequency of 1,000 Hz was applied to a SUS substrate or a NiP substrate at a fluence higher than 0.12 J/cm², irregularities with a large pitch of about 600 to 800 nm were formed (open diamond dots in FIG. 18 or open triangle dots in FIG. 19). More specifically, the pitch of irregularities formed on a substrate changed largely at 0.12 J/cm². When a laser beam with a wavelength of 800 nm and a repetition frequency of 1,000 Hz was applied to a SUS substrate or a NiP substrate at a fluence higher than 0.12 J/cm², the irregularities formed extended in a direction parallel to the polarization direction of the laser beam. However, when a laser beam was applied to a SUS substrate or a NiP substrate at a fluence of 0.04 J/cm² or higher and 0.12 J/cm² or lower, the irregularities formed extended in a direction orthogonal to the polarization direction of the laser beam. More specifically, the relation between the direction of irregularities formed on a SUS substrate or a NiP substrate and the polarization direction of the laser beam changes at 0.12 J/cm².

FIG. 20 shows the laser processing conditions for some of the solid diamonds in FIG. 18 and the laser processing conditions for some of the solid triangles in FIG. 19, together with the pitch of the irregularities formed, an arithmetic mean roughness Ra, and the presence or absence of liquid crystal alignment. The pitch and Ra in FIG. 20 were measured using an AFM (Atomic Force Microscope). FIG. 21(A) was obtained by measuring the irregularities in S3 in FIG. 20 using the AFM. FIG. 21(B) was obtained by measuring the irregularities in N3 in FIG. 20 using the AFM.

As can be seen from FIG. 20, when the F was maintained constant, the pitches of irregularities were almost constant for the same substrate material even when the number of pulses N (actually v) was changed. More specifically, the pitch of irregularities formed on a substrate does not depend on the number of pulses N.

The number of pulses N is the number of pulses applied to a single point and can be determined by the following formula.

N=f_{REPT}×Ly/v

Ly: size of laser beam in direction of scanning

v: scanning speed of laser

As can be seen from FIGS. 21(A) and 21(B), the depth of the irregularities formed on the substrates was about 2 nm to about 80 nm, and their arithmetic mean roughness was about 1 nm to about 20 nm. More specifically, the depth of the irregularities shown in FIGS. 21(A) and 21(B) is significantly smaller than the depth of irregularities formed at a conventionally used high energy density (this depth is about several hundreds of nanometers). Attention will next be focused on the depths of irregularities on different substrate materials. The depths of the irregularities formed on the SUS substrates were significantly smaller than the depths of the irregularities formed on the Nip substrates. In addition, the pitches of the irregularities formed on the SUS substrates were significantly smaller than the pitches of the irregularities formed on the NiP substrates. Therefore, in order to align the liquid crystal, it is preferable to use a SUS substrate as the die (master plate) for transfer. However, in order to align the liquid crystal, a NiP substrate can, of course, be used as the die (master plate) for transfer.

As can be seen from FIGS. 21(A) and 21(B), it is not necessary that irregularities formed on a die have strict periodicity. Therefore, the pitch of irregularities is actually an average value obtained from the number of irregularities per unit length.

Another method of producing the die (master plate) for producing the substrate 11 will be described.

The master plate can be produced by coating the surface of a substrate such as a SUS substrate with a semiconductor material such as DLC (diamond-like carbon) and drawing a pattern using an ultra short pulse laser with a pulse width of 1 picosecond (10⁻¹² seconds) or shorter, or a so-called femtosecond laser, to form irregularities with a small pitch on the surface of the coating. In this case, the irregularities can be formed under wider laser conditions than those for the above-described method in which only a metal material is used. In addition, since the depth of the irregularities formed is large so that the arithmetic mean roughness is 20 to 60 nm, the substrate prepared can have a roughness Ra of up to about 10 nm. Therefore, constraints on the production process can be relaxed.

Examples of the method of coating the surface of the substrate with the semiconductor material include plasma CVD and sputtering. In addition to the DLC, for example, fluorine (F)-doped DLC (hereinafter referred to as FDLC), titanium nitride, chromium nitride, etc. can be used as the semiconductor material for the coating. The thickness of the coating is, for example, about 1 μm.

FIG. 22 shows the laser conditions under which the pitch of irregularities formed on a SUS304 substrate coated with DLC (diamond-like carbon) (hereinafter referred to as a DLC substrate) is equal to or smaller than one-half of the laser wavelength. FIG. 23 shows the laser conditions under which the pitch of irregularities formed on a SUS304 substrate coated with fluorine-doped DLC (hereinafter referred to as an FDLC substrate) is equal to or smaller than one-half of the laser wavelength. As can be seen from FIGS. 22 and 23, when a femtosecond laser beam is applied to a semiconductor material such as DLC or FDLC, irregularities with a pitch equal to or smaller than one-half of the wavelength of the laser beam are formed.

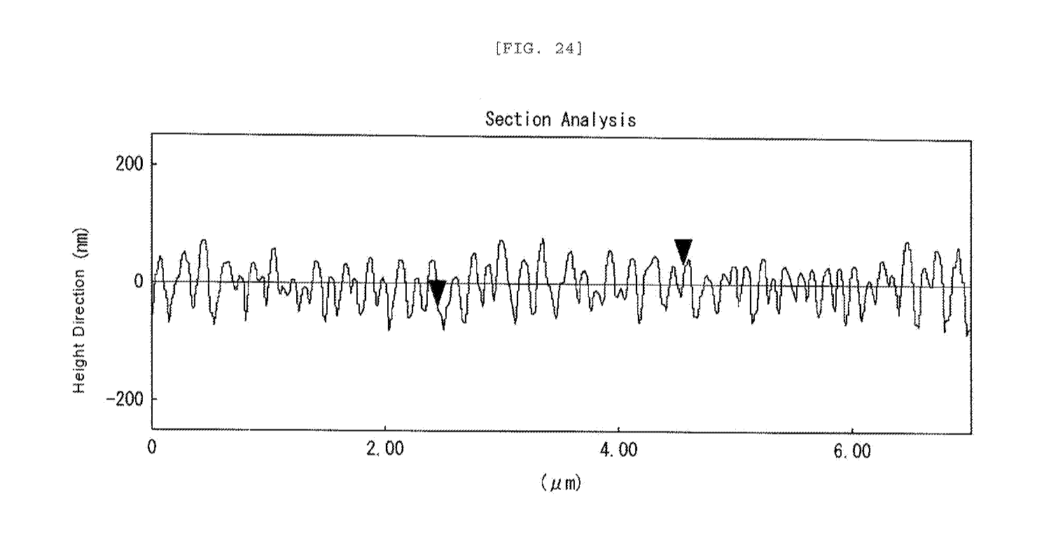

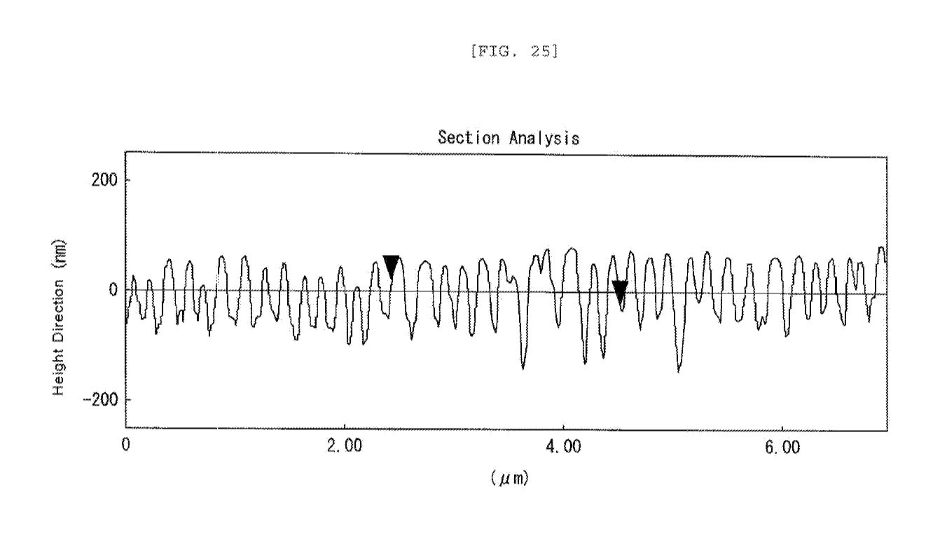

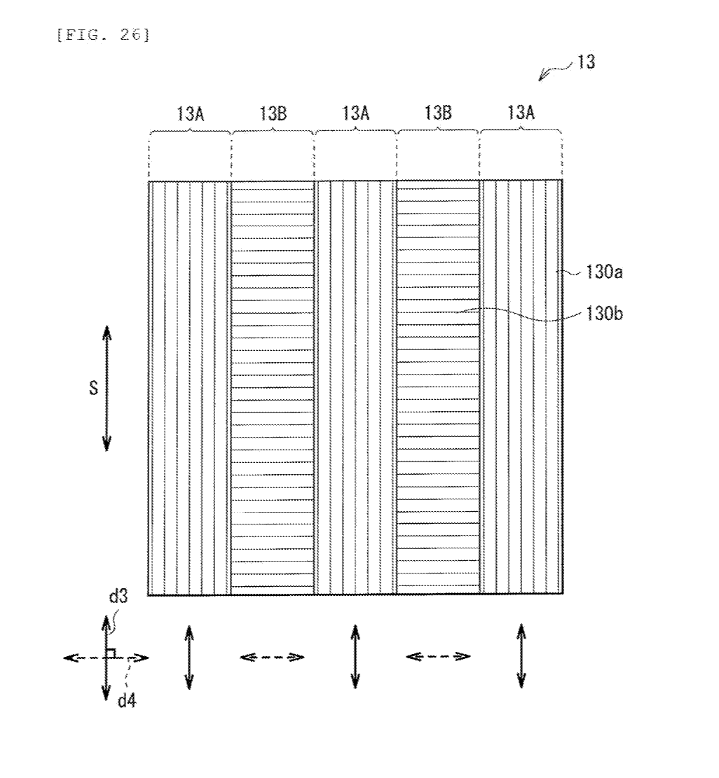

Table 1 shows the laser processing conditions for some of a plurality of solid circles in FIGS. 22 and 23, together with the pitch of irregularities formed, an arithmetic mean roughness Ra, and the presence or absence of liquid crystal alignment. The pitch and Ra in Table 1 were measured using an AFM. FIG. 24 was obtained by measuring the irregularities in D1 in Table 1 using the AFM. FIG. 25 was obtained by measuring the irregularities in F1 in Table 1 using the AFM.

TABLE 1

| | | | | | | | | Irregularities | | |
|---|---|---|---|---|---|---|---|---|---|---|
| | | Laser Processing Conditions | | | | | | of Die | | Liquid |
| Condition | Type of | | Lx | Ly | | | F | Pitch | Ra | Crystal |
| ID | Die | P (mW) | Horizontal (μm) | Vertical (μm) | V (mm/s) | N | (J/cm²) | (nm) | (nm) | Alignment |
| D1 | DLC | 114 | 300 | 190 | 1.9 | 100 | 0.2 | 125 | 30 | ◯ (OK) |
| D2 | | 114 | 300 | 190 | 6.3 | 30 | 0.2 | 125 | 29 | ◯ (OK) |
| F1 | FDLC | 114 | 300 | 190 | 6.3 | 30 | 0.2 | 179 | 49 | ◯ (OK) |
| F2 | | 80 | 300 | 190 | 6.3 | 30 | 0.14 | 140 | 35 | ◯ (OK) |

As can be seen from FIGS. 24 and 25, the pitch of the irregularities formed on the substrates was about 125 nm to about 180 nm and was equal to or smaller than one-half of the wavelength of the applied laser beam of 800 nm. In addition, the depth of the irregularities formed on the substrates was about 140 nm to about 200 nm, and their arithmetic mean roughness was about 30 nm to about 50 nm. More specifically, the depths of the irregularities shown in FIGS. 24 and 25 are approximately equal to the depth (about several hundreds of nanometers) of irregularities formed by irradiating a conventional metal material such as SUS with high energy.

More specifically, the irregularities formed on the semiconductor material can have a pitch smaller than the pitch of irregularities formed by irradiating the conventional metal material such as SUS with high energy, while the depths of the irregularities on these materials are approximately the same.

### [1.4 Effects]

The effects of the production methods in the above embodiments will next be described.

It is generally known that a liquid crystal is more easily aligned as the pitch of irregularities decreases. Generally, the pitch of irregularities formed using light is larger than one-half of the wavelength of the light. Therefore, to form irregularities with a pitch that allows a liquid crystal to be easily aligned, a laser beam with a wavelength close to the pitch that allows the liquid crystal to be easily aligned must be used. However, even the use of such a laser beam has a problem in that the liquid crystal may not be easily aligned in the direction of the irregularities because of separation stress generated when a transferred resin is separated from a master plate.

However, in the method of producing the die 210 (master plate) in one embodiment, a femtosecond laser beam is applied at a fluence equal to or lower than the prescribed threshold value (i.e., a low fluence) to draw a pattern including irregularities with a pitch equal to or smaller than one-half of the wavelength of the laser beam. For example, when a femtosecond laser beam with a wavelength of 800 nm and a repetition frequency of 1,000 Hz is applied to a SITS substrate at a fluence of 0.04 J/cm² or higher and 0.12 J/cm² or lower, irregularities with a pitch of about 80 nm are formed. In addition, for example, when a femtosecond laser beam with a wavelength of 800 nm and a repetition frequency of 1,000 Hz is applied to a NiP substrate at a fluence of 0.04 J/cm² or higher and 0.12 J/cm² or lower, irregularities with a pitch of about 240 nm are formed.

In the method of producing the die 210 (master plate) in another embodiment of the present invention, a femtosecond laser beam is applied to a semiconductor material such as DLC or FDLC, and irregularities with a pitch equal to or smaller than one-half of the wavelength of the laser beam are formed. For example, when DLC is used, irregularities with a pitch of about 125 nm are formed. For example, when FDLC is used, irregularities with a pitch of about 140 nm to about 180 nm are formed.

Therefore, for example, irregularities on the die 210 (master plate) are transferred onto the substrate 11 (alignment film), and then the die 210 is separated from the substrate 11. The substrate 11 thus produced can have a high anchoring force. This allows the influence of separation stress during transfer to be neglected when a polymerizable liquid crystal material is applied to the substrate 11, then aligned, and polymerized. Therefore, in the above embodiments, a non-alignment thin film layer can be omitted from the retardation film 10. Accordingly, while optical properties are improved, an increase in production cost can be suppressed.

### 2. Modifications

Modifications of the retardation film 10 will next be described with reference to the drawings. In the following description, the same components as those in the retardation film 10 are denoted by the same reference numerals, and the description thereof will be appropriately omitted. Modifications 1 to 7 are modifications to the structure of the retardation film 10. In examples shown in the modifications 1 to 7, the substrate 11 used has a single-layer structure. However, of course, a substrate having a multilayer structure (for example, a two-layer structure including a substrate and a resin layer formed on the surface of the substrate) can also be used.

### Modification 1

FIG. 26 shows a substrate 13 of a retardation film according to the modification 1 as viewed from its front surface side. In this modification, the structure of the substrate 13 is the same as the structure of the retardation film 10 in the above embodiments except for the structure of groove regions 13A and 13B formed on the surface of the substrate 13.

The groove regions 13A and 13B have, for example, a stripe shape and are arranged alternately on the surface of the substrate 13. Each of the groove regions 13A includes a plurality of grooves 130a extending in one direction d3, and each of the groove regions 13B includes a plurality of grooves 130b extending in one direction d4. The directions d3 and d4 are orthogonal to each other. However, in this modification, the directions d3 and d4 form angles of 0° and 90°, respectively, with respect to a stripe direction S of the groove regions 13A and 13B. The cross-sectional shape of each of the grooves 130a and 130b is, for example, a V-shape, as in the grooves 111a and 111b in the above embodiments.

A retardation layer having retardation regions (not shown) with different retardation characteristics is formed for these groove regions 13A and 13B. More specifically, the retardation regions having a stripe shape are formed in contact with the surface of the substrate 13 such that their optical axes are arranged alternately in the directions d3 and d4. In this modification, the retardation layer is formed of the same liquid crystal material as that of the retardation layer 12 in the above embodiments, and the respective retardation regions are formed of the same material and have the same thickness. Therefore, these retardation regions have retardation characteristics with the same retardation value while the optical axes of the retardation regions extend in the directions d3 and d4, respectively.

When the retardation film in this modification is produced, a die roll having formed thereon a reversal pattern of the groove regions 13A and 13B is pressed against the surface of the substrate 13 to perform transfer in the step of forming the groove regions 13A and 13B, and the other steps are the same as those for the retardation film 10 in the above embodiments.

The extending directions d3 and d4 of the grooves 130a and 130b in the groove regions 13A and 13B may be parallel to or orthogonal to the stripe direction S, as in this modification. No particular limitation is imposed on the angles between the stripe direction S and the extending directions of grooves in respective groove regions, so long as the extending directions are orthogonal to each other. When the retardation film in this modification is used in combination with a polarizer, the retardation film is disposed such that the angles between the transmission axis direction of the polarizer and the directions d3 and d4 are 45°.

### Modification 2

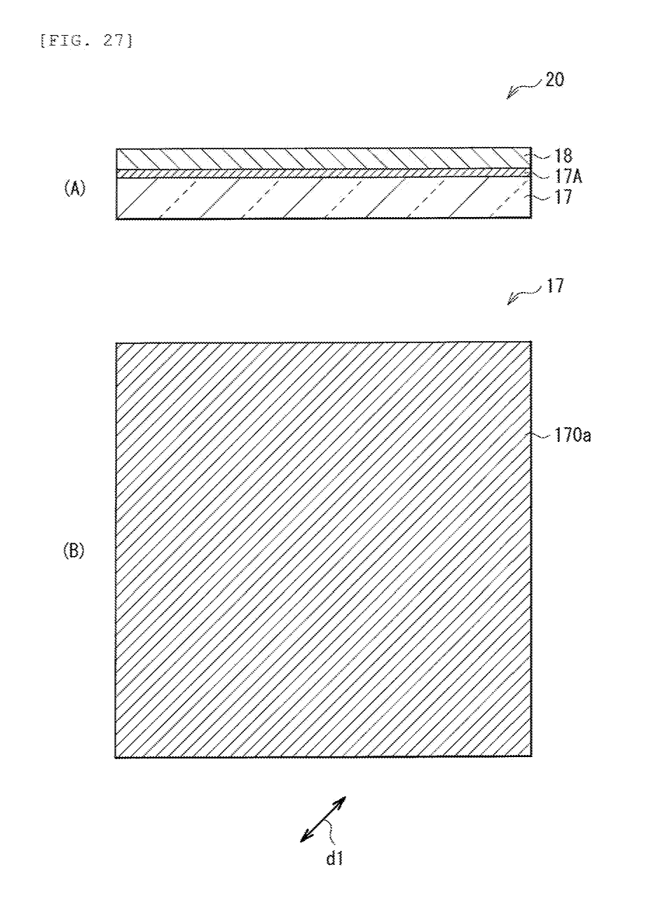

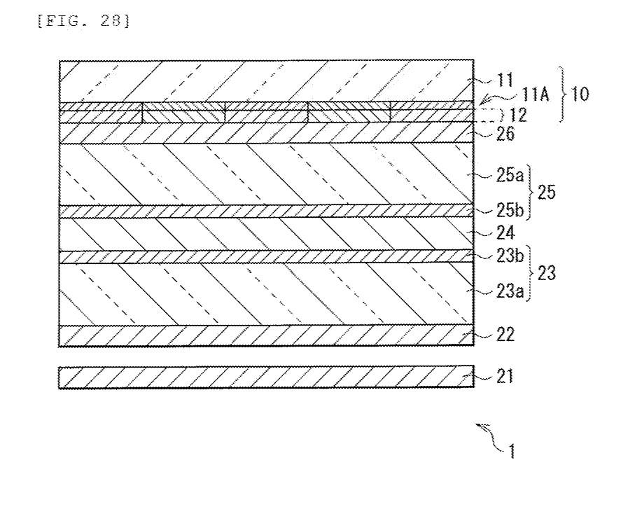

FIG. 27(A) shows the cross-sectional structure of a retardation film 20 according to the modification 2. FIG. 27(B) shows a substrate 17 as viewed from its front surface side. The retardation film 20 has a groove region 17A patterned on the surface of the substrate 17, and a retardation layer 18 is formed in contact with the surface of the substrate 17. In this modification, the groove region 17A is formed on the entire surface of the substrate 17. The groove region 17A includes a plurality of grooves 170a extending in one direction d1.

As described above, the groove region 17A is not necessarily patterned in a stripe shape on the surface of the substrate 17. The retardation film 10 described in the above embodiments is suitable as a component of, for example, a 3D display, as described above. The retardation film 20 in this modification can be suitably used not only for such a 3D display but also as, for example, a viewing angle compensation film (for example, an A plate) of a typical display for two-dimensional display. The retardation film 20 can also be used as a retardation film for 3D polarized glasses used for viewing a 3D display.

### Modification 3

In the examples described in the above embodiments and the modifications thereof, the grooves have a V-shaped cross-section. However, the cross-sectional shape of the grooves is not limited to the V shape and may be another shape such as a circular shape or a polygonal shape. The shapes of the grooves are not necessarily the same, and the depths and sizes of the grooves may be different for different regions on the substrate.

### Modification 4

In the examples of the configuration described in the above embodiments and the modifications thereof, the plurality of grooves are densely arranged in the groove regions with no gaps, but this is not a limitation. A prescribed gap may be provided between the grooves. In the description of the above examples, the grooves are formed over the entire surface. However, the grooves may be provided only in local regions on the substrate according to the required retardation characteristics.

### 3. Application Examples

### Application Example 1

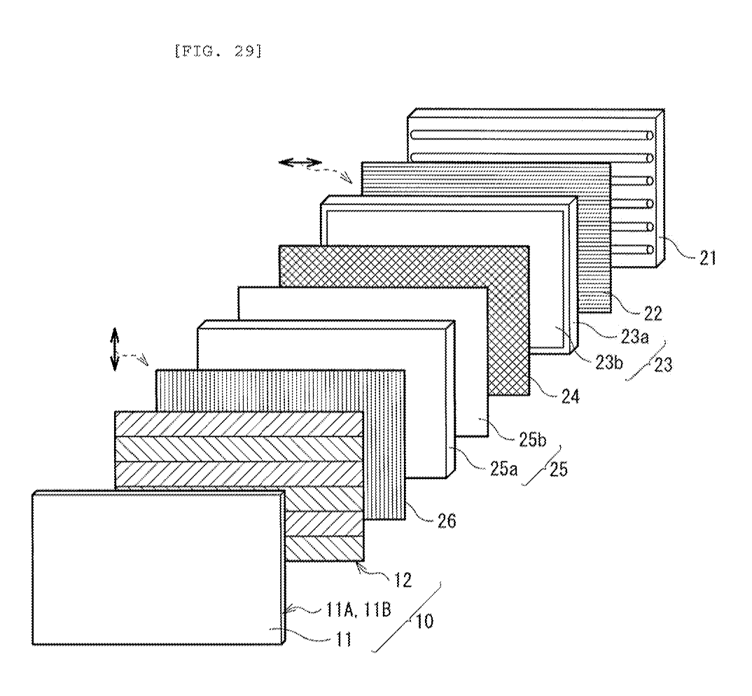

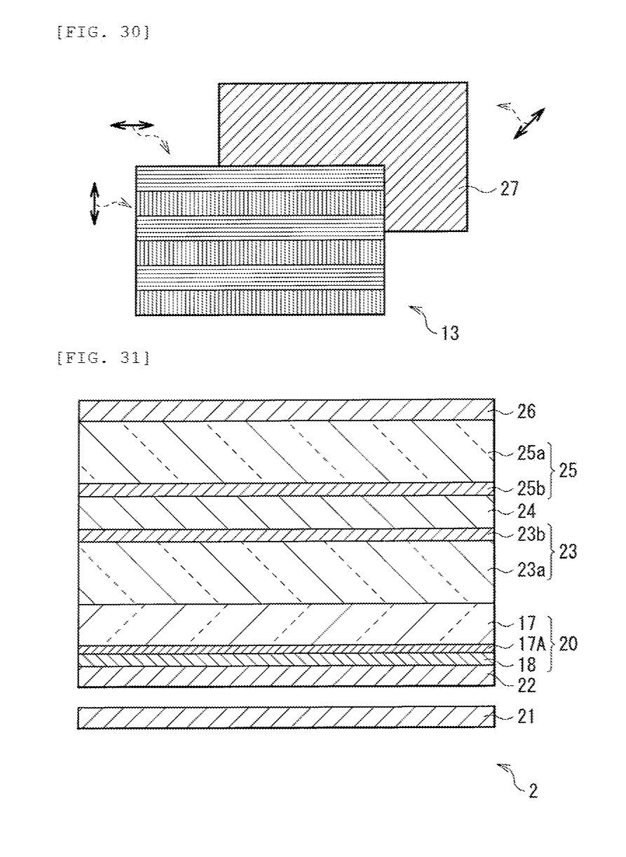

FIG. 28 shows the cross-sectional structure of a display device 1 according to an application example 1. FIG. 29 is a schematic diagram illustrating the stacking structure of the display device 1. This display device 1 displays, for example, two-dimensional images based on a right-eye image signal and a left-eye image signal, and is a 3D display that allows a stereoscopic view when these two-dimensional images are observed using polarized glasses.

The display device 1 includes, for example, a plurality of pixels of three primary colors, red (R), green (G), and blue (B), arranged in. a matrix form. The display device 1 further includes a backlight 21, a polarizer 22, a driving substrate 23, a liquid crystal layer 24, a counter substrate 25, and a polarizer 26 that are arranged in that order on the backlight 21. The above-described retardation film 10 is applied to the light-emitting side of the polarizer 26 such that, for example, the retardation layer 12 faces the polarizer 26. In this configuration, the retardation layer 12 is disposed such that the directions of the optical axes of the retardation regions 12a and 12b form an angle of 45° with respect to the transmission axis of the polarizer 26. The groove regions 11A and 11B of the retardation film 10 correspond to even-numbered lines and odd-numbered lines in a display pixel region, respectively, and the stripe width of the groove regions 11A and 11B is equal to the pitch of the pixels.

The backlight 21 is, for example, of the edge-light type using a light guide plate or the direct type and. is configured to include, for example, CCFLs (Cold Cathode Fluorescent Lamps), LEDs (Light Emitting Diodes), or the like.

For example, the driving substrate 23 includes pixel driving elements such as TFTs (Thin Film Transistors) formed on the surface of a transparent substrate 23a such as a glass substrate. The counter substrate 25 includes a color filter layer 25b for the three primary colors formed on the surface of a transparent substrate 25a such as a glass substrate.

The liquid crystal layer 24 is formed of, for example, a liquid crystal material such as a nematic liquid crystal, a smectic liquid crystal, or a cholesteric liquid crystal, and the liquid crystal material is, for example, a VA (Vertical Alignment) mode, IPS (In-Plane Switching) mode, or TN (Twisted Nematic) mode liquid crystal. An alignment film (not shown) for controlling the alignment of liquid crystal molecules in the liquid crystal layer 24, for example, a polyimide alignment film, is disposed between the liquid crystal layer 24 and the driving substrate 23, and another alignment film (not shown) is disposed between the liquid crystal layer 24 and the counter substrate 25.

The polarizers 22 and 26 are designed such that polarized light vibrating in a specific direction is allowed to path therethrough and polarized light vibrating in a direction orthogonal to the specific direction is absorbed or reflected. The polarizers 22 and 26 are disposed such that their transmission axes are orthogonal to each other. In this configuration, the polarizer 22 is designed to allow a component polarized in a horizontal direction to selectively pass therethrough, and the polarizer 26 is designed to allow a component polarized in a vertical direction to selectively pass therethrough.

In the above display device 1, when the light emitted from the backlight 21 enters the polarizer 22, only the light component polarized in the horizontal direction passes through the polarizer 22, passes through the driving substrate 23, and enters the liquid crystal layer 24. The incident light is modulated in the liquid crystal layer 24 according to an image signal and passes therethrough. Red light, green light, and blue light for three primary color pixels are extracted through the color filter 25b in the counter substrate 25 from the light passing through the liquid crystal layer 24, and then only light components polarized in the vertical direction pass through the polarizer 26. The polarized components passing through the polarizer 26 are converted to light components having prescribed polarized states through the respective retardation regions 12a and 12b in the retardation layer 12 in the retardation film 10 and are emitted from the substrate 11. The light thereby emitted from the retardation film 10 is recognized as a three-dimensional stereoscopic image by a viewer wearing polarized glasses. Since no alignment film is formed in the retardation film 10 as described above, the occurrence of light loss by the retardation film 10 can be suppressed, and the efficiency of utilization of light is thereby improved. Therefore, display brighter than that in conventional devices can be achieved.

When the retardation film according to the modification 1 described above is applied to the display device 1 described above, for example, a polarizer 27 having a transmission axis forming an angle of 45° with respect to the horizontal direction is used, as shown in FIG. 30. In this configuration, the polarizer 27 is disposed such that the direction of its transmission axis and the directions of the optical axes of the respective retardation regions of the retardation film form an angle of 45°.

Since the retardation film 10 is applied to the front surface of the display device 1, the retardation film 10 is disposed on the outermost side of the display. Therefore, to improve contrast at a bright place, it is preferable to provide an antireflection layer (not shown) or an anti-glare layer (not shown) on the rear surface of the substrate 11. In addition, regions around boundaries between retardation patterns may be covered with a black pattern. Such a configuration can suppress the occurrence of crosstalk between the retardation patterns.

When the display device 1 is produced, the retardation film 10 is produced by any of the production methods in the above embodiments and the modifications thereof. For example, a substrate 11 produced by thermal transfer or transfer using the 2P molding method is coated with a polymerizable liquid crystal material. The polymerizable liquid crystal material is polymerized, and the retardation film 10 is thereby produced. In this case, the pitch of the irregularities on the substrate 11 is equal to or smaller than one-half of the wavelength of the laser beam, and the substrate 11 has an increased anchoring force. For example, the substrate 11 (alignment film) is transferred from the die 210 (master plate), and the die 210 is separated. Then a polymerizable liquid crystal material is applied to the substrate 11, then aligned, and polymerized. In this case, the influence of separation stress during transfer can be neglected.

Therefore, the retardation film 10 in which the liquid crystal has been aligned with no non-alignment thin film layer provided can be used. Accordingly, while optical properties are improved, an increase in production cost can be suppressed. Also in the following application examples, the retardation film 10 in which the liquid crystal has been aligned with no non-alignment thin film layer provided can be used. Accordingly, while optical properties are improved, an increase in production cost can be suppressed.

### Application Example 2

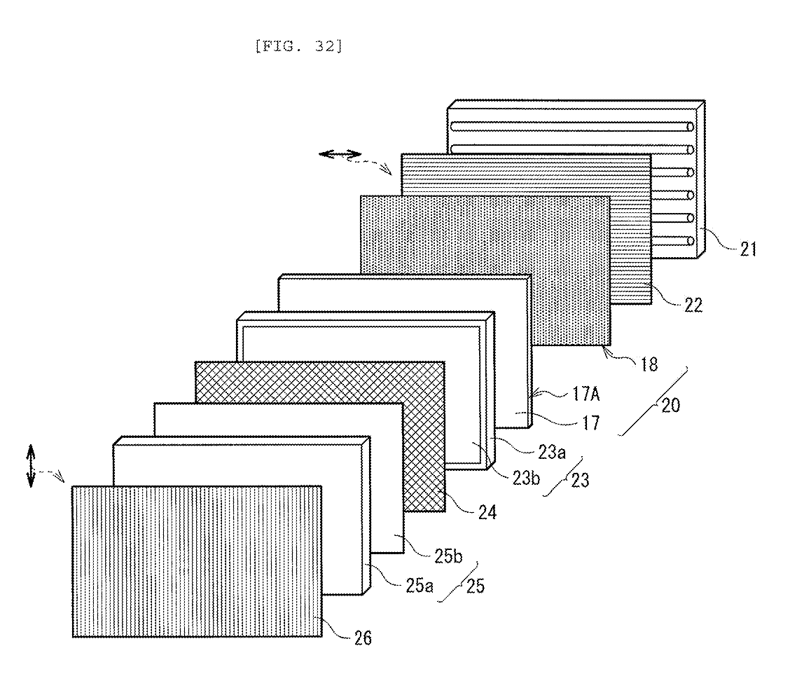

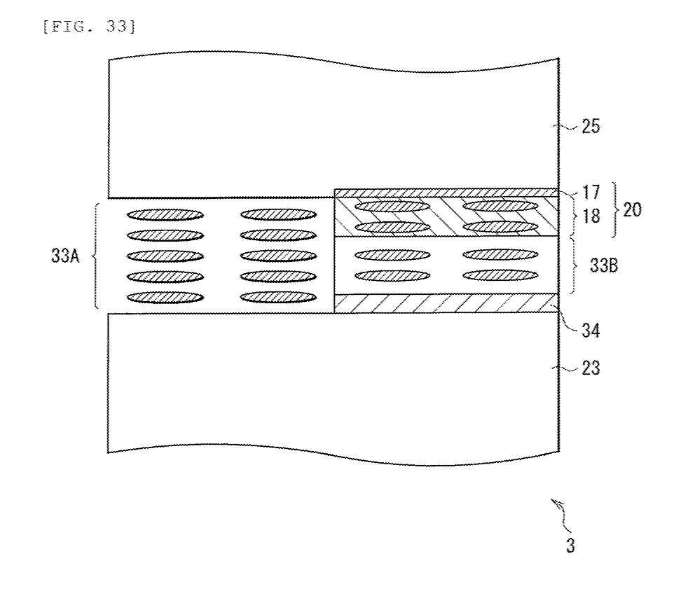

FIG. 31 shows the cross-sectional structure of a display device 2 according to the application example 2. FIG. 32 is a schematic diagram illustrating the stacking structure of the display device 2. The display device 2 is, for example, a liquid crystal television or a two-dimensional display for a personal computer etc., and the retardation film 20 is used as a viewing angle compensation film. The display device 2 includes a backlight 21, a polarizer 22, a driving substrate 23, a liquid crystal layer 24, a counter substrate 25, and a polarizer 26 that are arranged in that order on the backlight 21, and the retardation film 20 according to the modification 2 is disposed on the light-emitting side of the polarizer 22. As described above, the retardation film 20 is one (an A plate) in which the polymerizable liquid crystal in the retardation layer 18 has been uniformly aligned in the extending direction of the grooves. In this configuration, the retardation film 20 is disposed such that the angle between the extending direction of the grooves on the retardation film 20, i.e., the direction of the optical axis, and the direction of the transmission axis of the polarizer 22 is 0°.

In addition to the A plate, a C plate etc. can be used as the viewing angle compensation film used in the above-described display. For example, a retardation film in which biaxiality has been imparted to its retardation layer by irradiation with polarized ultraviolet light can also be used. However, when a VA mode liquid crystal is used for the liquid crystal layer 24, it is preferable to use the A plate, the C plate, or both of them.

In a retardation film used as the C plate, the retardation layer has, for example, a chiral nematic phase (a cholesteric phase), and the direction of the optical axis thereof coincides with the normal to the substrate surface. In the C plate, liquid crystal molecules aligned in the extending direction of the grooves have formed a helical structure having a helical axis extending in a direction normal to the substrate surface by addition of a chiral agent or the like. As described above, the retardation film may have a structure in which the alignment of liquid crystal molecules varies in the thickness direction of the retardation layer. In other words, the extending direction of the grooves and the direction of the optical axis of the retardation film may foe different from each other. This is because the final optical anisotropy of the retardation film is determined depending on the alignment state of the liquid crystal molecules in the thickness direction.

In such a display device 2, when the light emitted from the backlight 21 enters the polarizer 22, only the light component polarized in the horizontal direction passes through the polarizer 22 and then enters the retardation film 20. The light passing through the retardation film 20 passes through the driving substrate 23, the liquid crystal layer 24, the counter substrate 25, and the polarizer 26 in that order and is then emitted from the polarizer 26 as a light component polarized in the vertical direction. Two-dimensional display is thereby achieved. Since the retardation film 20 is disposed, retardation in the liquid crystal as viewed from an oblique direction is compensated, and the amount of light, leakage in an oblique direction in black display and the degree of coloration can be reduced. More specifically, the retardation film 20 can be used as the viewing angle compensation film. In this case, since no alignment film is formed in the retardation film 20, the occurrence of light loss by the retardation film 20 is suppressed, and the efficiency of utilization of light is thereby improved. Therefore, display brighter than that in conventional devices can be achieved.

The retardation film 20 serving as the viewing angle compensation film may be disposed between the polarizer 22 and the driving substrate 23 in the display device 1 for 3D display according to the application example 1 described above. In the example of the configuration described above, the retardation film 20 is disposed such that the angle between the direction of its optical axis d1 and the direction of the transmission axis of the polarizer 22 is 0°. However, the angle between these directions is not limited to 0°. For example, when a circularly polarizing plate is used as the polarizer 22, the retardation film 20 is disposed such that the angle between its optical axis direction d1 and the direction of the transmission axis of the polarizer 22 is 45°.

### Application Example 3

FIG. 33 shows the cross-sectional structure of a display device 3 according to an application example 3. The display device 3 is, for example, a semi-transmissive two-dimensional display. In this display device 3, the retardation film 20 serving as the viewing angle compensation film and liquid crystal layers 33A and 33B for display modulation are formed between a driving substrate 23 and a counter substrate 25. More specifically, a reflective layer 34 is disposed in a selective region on the driving substrate 23, and the retardation film 20 is formed on a side close to the counter substrate 25 and located in a region facing the reflective layer 34. The liquid crystal layer 33B is sealed between the driving substrate 23 and the retardation film 20. The liquid crystal layer 33A is sealed in another region between the driving substrate 23 and the counter substrate 25. The liquid crystal layers 33A and 33B modulate light when voltage is applied thereto, and their retardations are λ/2 and λ/4, respectively. A backlight 21 and a polarizer 22 (not shown in FIG. 33) are disposed below the driving substrate 23, and a polarizer 26 (not shown in FIG. 33) is disposed above the counter substrate 25.

As described above, the configuration in which the retardation film 20 serving as the viewing angle compensation film is disposed inside a liquid crystal cell, i.e., an in-cell structure, may be used.

1. A method of producing a master plate, comprising: using a femtosecond laser to irradiate a surface of a base substrate with a linearly polarized laser beam with a fluence equal to or lower than a prescribed threshold value; and, at the same time, scanning the surface with the linearly polarized laser beam to draw a pattern including irregularities with a pitch equal to or smaller than one-half of a wavelength of the laser beam.

2. The method of producing a master plate according to claim 1, wherein the threshold value is 0.12 J/cm².

3. The method of producing a master plate according to claim 1, wherein the irregularities extend in a direction parallel to a polarization direction of the laser beam.

4. The method of producing a master plate according to claim 3, wherein the irregularities extend in a direction intersecting a direction of scanning with the laser beam.

5. The method of producing a master plate according to claim 3, wherein the irregularities extend in a direction parallel to a direction of scanning with the laser beam.

6. The method of producing a master plate according to claim 3, wherein the fluence has a lower limit of 0.04 J/cm2.

7. The method of producing a master plate according to claim 3, wherein the die is made of SUS or NiP.

8. The method of producing a master plate according to claim 3, wherein a repetition frequency of the laser beam is 1,000 Hz or larger.

9. A method of producing an alignment film, comprising the steps of:
forming a die, the step including using a femtosecond laser to irradiate a surface of a base substrate with a linearly polarized laser beam with a fluence equal to or lower than a prescribed threshold value and, at the same time, scanning the surface with the linearly polarized laser beam to draw a pattern including irregularities with a pitch equal to or smaller than one-half of a wavelength of the laser beam; and
forming a plurality of grooves extending in a specific direction on a surface of a substrate using the die.

10. The method of producing an alignment film according to claim 9, wherein the threshold value is 0.12 J/cm2.

11. The method of producing an alignment film according to claim 9, wherein the irregularities extend in a direction parallel to a polarization direction of the laser beam.

12. The method of producing an alignment film according to claim 9, wherein formation of the pattern using the die is performed by thermal transfer or transfer using a 2P (Photo Polymerization) molding method.

13. The method of producing an alignment film according claim 9, wherein the pattern includes a plurality of first grooves extending in a first direction and a plurality of second grooves extending in a second direction orthogonal to the first direction, and
a first groove region comprising the plurality of first grooves and a second groove region comprising the plurality of second grooves each have a stripe shape extending in the scanning direction and are arranged alternately.

14. The method of producing an alignment film according to claim 9, wherein the substrate is made of a plastic material.

15. The method of producing an alignment film according claim 9, wherein the substrate is made of a base substrate on a surface of which a resin layer is formed.

16. A method of producing a retardation film, comprising the steps of:
forming a die, the step including using a femtosecond laser to irradiate a surface of a base substrate with a linearly polarized laser beam with a fluence equal to or lower than a prescribed threshold value and, at the same time, scanning the surface with the linearly polarized laser beam to draw a pattern including irregularities with a pitch equal to or smaller than one-half of a wavelength of the laser beam;
forming a plurality of grooves extending in a specific direction on a surface of a substrate using the die;
applying a polymerizable liquid crystal material to the surface of the substrate having the plurality of grooves formed thereon and then aligning the liquid crystal material; and
polymerizing the liquid crystal material.

17. The method of producing a retardation film according to claim 16, wherein the threshold value is 0.12 J/cm2.

18. The method of producing a retardation film according claim 16, wherein the irregularities extend in a direction parallel to a polarization direction of the laser beam.

19. A method of producing a display device provided with a retardation film, comprising the steps of:
forming a die, the step including using a femtosecond laser to irradiate a surface of a base substrate with a linearly polarized laser beam with a fluence equal to or lower than a prescribed threshold value and, at the same time, scanning the surface with the linearly polarized laser beam to draw a pattern including irregularities with a pitch equal to or smaller than one-half of a wavelength of the laser beam;
forming a plurality of grooves extending in a specific direction on a surface of a substrate using the die;
applying a polymerizable liquid crystal material to the surface of the substrate having the plurality of grooves formed thereon and then aligning the liquid crystal material; and
polymerizing the liquid crystal material to form the retardation film.
